(19) United States
(12) Patent Application Publication
(10) Pub. No.: US 2025/0323335 A1
(43) Pub. Date: Oct. 16, 2025

(54) SPENT BATTERY MATERIALS RECYCLING METHOD

(71) Applicant: National University of Singapore, Singapore (SG)

(72) Inventors: Qing Wang, Singapore (SG); Yongfeng Zhi, Singapore (SG); Songpeng Huang, Singapore (SG); Feifei Zhang, Singapore (SG)

(73) Assignee: National University of Singapore, Singapore (SG)

(21) Appl. No.: 18/869,096

(22) PCT Filed: May 24, 2023
(86) PCT No.: PCT/SG2023/050364

§ 371 Date: Nov. 25, 2024

(30) Foreign Application Priority Data
May 25, 2022 (SG) 10202205575S

(51) Int. Cl. H01M 10/54; C25B 1/16; C25B 1/50; C25B 9/77; C25B 15/08; H01M 4/505; H01M 4/525

(52) U.S. Cl. CPC H01M 10/54; C25B 1/16; C25B 1/50; C25B 9/77; C25B 15/087; H01M 4/505; H01M 4/525

(57) ABSTRACT

Disclosed herein is a method of recycling a spent battery material, the method comprising the steps of (a) providing a first reaction compartment fluidly connected to a cathode side of an electrolyser, (b) in a second reaction compartment, LiOH is added to precipitate the Co²⁺ to provide a filtered alkaline electrolyte solution which is supplied to a third reaction compartment when the Co²⁺ are substantially or are entirely removed from the filtered alkaline electrolyte solution by precipitation, and (c) in an initial state, the reaction compartment houses FePO₄ and accepts the filtered alkaline electrolyte solution from the second reaction compartment, the reaction loops are continued until the Li⁺ ions are substantially or are entirely removed from the electrolyte. Also disclosed herein are an electrolytic device comprising an electrolyser, a first to third cathode tank, and an anode tank, and an electrolytic device comprising a first electrolyser, and a second electrolyser.

### FIELD OF INVENTION

This invention discloses a high-throughput electrolytic flow cell system to continuously break down the spent lithium-ion battery (LIB) materials into valuable chemicals at ambient conditions, without consuming additional chemicals. It leverages the complementary oxidative leaching and reductive leaching reactions of two mainstream LIB materials—LiFePO₄ and LiCoO₂ (or LiNiₓMn_{y}Co_{z}O₂) in one holistic process, to disruptively minimise the secondary pollution, CO₂ emission and energy consumption.

### BACKGROUND

The listing or discussion of a prior-published document in this specification should not necessarily be taken as an acknowledgement that the document is part of the state of the art or is common general knowledge.

LIB electrode materials, such as lithium cobalt oxide (LCO), lithium iron phosphate (LiFePO₄, LFP), and lithium manganese oxide (LiMnO₂, LMO), lithium nickel manganese cobalt oxide (LiNiₓMnCo₁₋ₓO₂, NMC) and lithium nickel cobalt alumina (LiNiCoAlO₂, NCA), and many other ternary lithium ion battery, will face significant increase in their production, which will not only lead to the depletion of natural resources, but also lead to environmental problems related to mining and mineral processing activities, such as ground and water pollution, ecosystem destruction and greenhouse gas emissions. In recent years, with the increasing awareness of environmental protection and the demand for electrode materials, the recycling of lithium-ion battery materials has also become a focus of research. Although physical, chemical and biological methods have achieved the recovery of metal ions from electrode materials in spent lithium ion batteries, they all spend much chemical agent and the amount of secondary pollutants produced do not meet global targets for reductions in environment pollution emissions.

Since lithium cobalt oxide (LiCoO₂, LCO) was first used as a commercial cathode material by SONY in 1991, the demand for LiCoO₂ is increasing with the use of more and more portable electronic devices, which leads to the continuous increase of the amount of LiCoO₂ discarded along with its spent battery flow. In addition, the price of cobalt in waste lithium cobalt oxide batteries is more expensive than lithium. Low abundance in nature ores and uneven distribution of the limited cobalt resources has caused the manufacturing cost of lithium cobalt oxide batteries to continue to rise. Another serious problem is the toxicity of cobalt that can easily cause environmental pollution. Therefore, either from an environmental or an economic point of view, recycling waste lithium cobalt oxide batteries is a strategy that kills two birds with one stone.

Pyrometallurgy, hydrometallurgy, and bio-metallurgy, as the most researched LCO recovery strategies, have achieved good recovery efficiency. Pyrometallurgical technology requires high-temperature operation, which inevitably consumes a lot of energy and produces some industrial waste gas; directly renovating spent battery requires additional consumption of a large amount of chemicals by this method, and the used reagents are difficult to recover. Hydrometallurgy technology has the advantages of high metal ion leaching rate, relatively mild reaction, and high recovery purity. It has also become the most commonly used method in industrial recovery. However, more inorganic acids (such as strong corrosive acids like sulfuric acid, hydrochloric acid, nitric acid, etc.) or organic acids (such as acetic acid, citric acid, ascorbic acid, oxalic acid and others) need to be used in the leaching process. In many cases, additional reducing agents (such as hydrogen peroxide and other reduction reagents) are required except ascorbic acid and oxalic acid. At the same time, the large amount of toxic gas emission and excessive acid-base consumption, inferior metal selectivity and equipment corrosion, have gradually emerged and restricted the promotion and development of this method. Although bio-metallurgy is an environmentally friendly technology, the long-term reaction is not conducive to large-scale industrial recycling of spent lithium-ion batteries.

Although abandoned lithium cobalt oxide electrode materials can partly dissolve under acid condition, trivalent cobalt ions Co(III) in LCO need to be reduced into divalent Co(II) soluble ions which can be completely dissolved, so the process need to consume large amounts of reducing reagent, such as H₂O₂. The slow leaching reaction rate and the hydrophobicity of the binder and conductive agent in the electrode materials result in incomplete leaching, which is often required to be carried out at high temperatures.

As such, from the perspective of sustainable development and green chemistry, it is essential to develop a sustainable closed-loop recycling technology for spent lithium cobalt oxide batteries.

### SUMMARY OF INVENTION

Aspects and embodiments of the invention are disclosed in the following numbered clauses.
1. A method of recycling a spent battery material, the method comprising the steps of:
(a) providing a first reaction compartment fluidly connected to a cathode side of an electrolyser that comprises a cathode compartment comprising a cathode, an anode compartment comprising an anode, and a cation exchange membrane separating the cathode and the anode compartments from one another, where an anode side of the electrolyser is set up to generate protons via an oxygen evolution reaction or a hydrogen oxidation reaction, where in an initial state the first reaction compartment comprises:
   a solid spent battery material comprising LiCoO₂ and/or LiNiₓMn_{y}Co_{z}O₂; and
   an acidic electrolyte comprising a first redox mediator capable of being reduced on the cathode, and
   during a first reductive loop, the acidic electrolyte from the first reaction compartment is provided to the first cathode compartment to provide a reduced first redox mediator and the acidic electrolyte is returned to the first reaction compartment where the reduced redox mediator reacts with the solid spent battery material producing soluble Li⁺, Co²⁺ and, when present, Ni²⁺ and Mn²⁺ ions, while the reduced first redox mediator is oxidised back to its original form and protons are supplied from the anode compartment via the cation exchange membrane,
   during subsequent reductive loops, the acidic electrolyte from the first reaction compartment comprises the first redox mediator, and Li⁺, Co²⁺ and, when present, Ni²⁺ and Mn²⁺ ions,
   the subsequent reaction loops are continued until the Li, Co and, when present, Ni and Mn have been dissolved from the solid spent battery material, whereupon the acidic electrolyte comprising the first redox mediator, and Li⁺, Co²⁺ and, when present, Ni²⁺ and Mn²⁺ ions is supplied to a second reaction compartment;
(b) in the second reaction compartment, the acidic electrolyte comprising the first redox mediator, and Li⁺, Co²⁺ and, when present, Ni²⁺ and Mn²⁺ ions, LiOH is added to precipitate the Co²⁺ and, when present, Ni²⁺ and Mn²⁺ ions to provide a filtered alkaline electrolyte solution comprising the first redox mediator, and Li⁺, which is supplied to a third reaction compartment when the Co²⁺ and, when present, Ni²⁺ and Mn²⁺ ions are substantially or are entirely removed from the filtered alkaline electrolyte solution by precipitation;
(c) in an initial state, the reaction compartment houses FePO₄ and accepts the filtered alkaline electrolyte solution from the second reaction compartment,
   during a first reaction loop, the filtered alkaline electrolyte is supplied from the third reaction compartment to the cathode compartment to provide an electrolyte comprising a reduced first redox mediator and Li⁺ ions and the electrolyte is returned to the third reaction compartment where the reduced redox mediator reacts with the FePO₄ producing LiFePO₄ and the reduced first redox mediator is oxidised back to its original form and protons are supplied from the anode compartment via the cation exchange membrane,
   during subsequent reaction loops, the electrolyte from the third reaction compartment comprises the first redox mediator, and a reduced concentration of Li⁺ ions,
   the subsequent reaction loops are continued until the Li⁺ ions are substantially or are entirely removed from the electrolyte, such that the electrolyte matches, or substantially matches, the acidic electrolyte of step (b), at which point the LiFePO₄ and any remaining FePO₄ are harvested.
2. The method according to Clause 1, further comprising the steps of:
(i) providing a fourth reaction compartment fluidly connected to an anode side of an electrolyser that comprises an anode compartment comprising an anode, a cathode compartment comprising cathode, and a cation exchange membrane separating the cathode and the anode compartments from one another, where the cathode side of the electrolyser is set up to generate hydrogen gas and hydroxide ions via a hydrogen evolution reaction, the cathode compartment being fluidly connected to a storage tank, where in an initial state the fourth reaction compartment comprises:
   the fourth reaction compartment the LiFePO₄ and any remaining FePO₄ harvested from step (d) of Clause 1 and an electrolyte comprising a second redox mediator capable of being oxidised on the anode; and
   the storage tank comprises water,
      during a first reaction loop, the electrolyte from the fourth reaction compartment is provided to the anode compartment to provide an oxidised second redox mediator and the electrolyte is returned to the fourth reaction compartment where the oxidised redox mediator reacts with the LiFePO₄ to provide FePO₄ and Li⁺ ions,
      during subsequent reaction loops the electrolyte comprising the redox mediator and Li⁺ ions is supplied to the anode compartment, where:
         the redox mediator is converted into an oxidised redox mediator; and
         at least some of the Li⁺ ions are transported through the cation exchange membrane into the cathode compartment and hence to the storage tank,
      the subsequent reaction loops are continued until the LiFePO₄ is substantially or entirely consumed and the storage tank comprises aqueous lithium hydroxide solution.
3. The method according to Clause 1 or Clause 2, wherein the first redox mediator has a redox potential lower than LiCoO₂ and/or LiNiₓMn_{y}Co_{z}O₂, optionally wherein the first redox mediator has a redox potential of less than 0.4 V vs standard hydrogen electrode (SHE), such as from 0.05 to 0.39 V vs SHE, such as about 0.23 V vs SHE or about 0.31 V vs SHE.
4. The method according to Clause 4, wherein the first redox mediator is one or both of Fe—SO₃Li and AQDS-2NH₄.
5. The method according to any one of the preceding clauses, wherein the first redox mediator has a concentration of from 1 to 100 mM in the acidic electrolyte, such as from 2 to 50 mM, such as about 40 mM or about 5 mM.
6. The method according to any one of the preceding clauses, wherein the acidic electrolyte is formed from water and an acidic compound, optionally wherein the acidic compound has a concentration of from 0.2 M to 5 M, such as from about 0.4 M to 3 M, further optionally wherein the acidic compound is sulphuric acid or acetic acid.
7. The method according any one of clauses 2 to 6, wherein the second redox mediator is Li₃[Fe(CN₆).
8. The method according to any one of the preceding clauses, wherein the method is operated as a closed loop.
9. An electrolytic device comprising:
   an electrolyser, which comprises a first cathode compartment comprising a cathode, a first anode compartment comprising an anode and a cation exchange membrane separating the first cathode and the first anode compartments from one another;
   a first to third cathode tank, where:
      the first cathode tank is fluidly connected to at least the cathode compartment and to the second cathode tank;
      the second cathode tank is fluidly connected to at least the first cathode tank and to the third cathode tank and can accept LiOH;
      the third cathode tank is fluidly connected to at least the first cathode tank, the second cathode tank and the first cathode compartment; and an anode tank fluidly connected to the first anode compartment, wherein:
   each of the first and third cathode tanks can be independently selected to be fluidly connected to the cathode compartment at any given time;
   the first cathode tank is configured to accept a spent battery material and an electrolyte and supply a liquid to the second cathode tank;
   the second cathode tank is configured to accept a liquid from the first cathode tank and to accept LiOH in solid and/or liquid form, and supply a liquid the third cathode tank; and
   the third cathode tank is configured to accept a liquid from the second cathode tank.
10. An electrolytic device comprising:
   a first electrolyser, which comprises a first cathode compartment comprising a cathode, a first anode compartment comprising an anode and a cation exchange membrane separating the first cathode and the first anode compartments from one another;
   a second electrolyser, which comprises a second cathode compartment comprising a cathode, a second anode compartment comprising an anode and a cation exchange membrane separating the first cathode and the first anode compartments from one another;
   a first anode tank fluidly connected to the first anode compartment;
   a second anode tank fluidly connected to the second anode compartment;
   a first cathode tank fluidly connected to the first cathode compartment;
   a second cathode tank fluidly connected to the second cathode compartment;
   a third cathode tank fluidly connected to the first cathode tank and the second cathode tank.

### DRAWINGS

FIG. 1 depicts (a-b) schematic illustration of the recycling process of spent lithium-ion battery (LIB) materials through complementary reductive leaching of LCO and oxidative leaching of LFP. The leaching of LCO operates upon a single-electrolyzer configuration, and the removal of Co²⁺ and Li⁺ proceed sequentially. CEM: cation exchange membrane.

FIG. 2 depicts (a) schematic illustration of the reductive redox targeting-based strategy for spent LCO material decomposing with oxygen evolution reaction (OER). (b) Energy diagram of the redox-mediated electrochemical cycle of reductive leaching of LCO and coupled OER.

FIG. 3 depicts (a) cyclic voltammograms (CVs) of AQDS-(NH₄)₂ in 3 M acetic acid and LiCoO₂ powder measured in 0.5 M H₂SO₄ solution. (b) Linear scan voltammetry (LSV) of 50 mM AQDS-(NH₄)₂ on a double-layer electrode in the absence (i) and presence (ii) of LiCoO₂. The insets illustrate the double-layer electrode structure. (c) LSV of AQDS-(NH₄)₂ solution after the open circuit potential (OCP) test. The inset shows the OCP results. (d) Voltage profile of reductive leaching of LCO in an electrolytic flow cell paired with OER reaction in the counter electrode at a constant current of 50 mA cm⁻².

FIG. 4 depicts (a) electrochemical characterizations of Co₃O₄/CeO₂ (prepared with 10 at % Ce) catalysts on carbon paper electrodes in 0.5 M H₂SO₄ solution CV curves of with or without catalysts. (b) Powder X-ray diffraction (PXRD) patterns of Co₃O₄/CeO₂ samples grown on carbon paper substrates by annealing at 400° C. for 2 h.

FIG. 5 depicts X-ray diffraction (XRD) pattern and Fourier-transform infrared spectroscopy (FT-IR) of Co(OH)₂ precipitated after adding LiOH.

FIG. 6 depicts (a) CVs of AQDS-(NH₄)₂ and FePO₄ powder in 1 M lithium acetate solution. (b) OCP of AQDS-(NH₄)₂ solution at different durations of reaction with excessive FePO₄. (c) Voltage profile of reductive removal of Li⁺ by FePO₄ (FP) in an electrolytic flow cell paired with OER reaction in the counter electrode at a constant current of 50 mA cm⁻². (d) XRD patterns of the FePO₄ powder before and after inserting Li⁺ and compared with the pristine LiFePO₄.

FIG. 7 depicts LSV of 5 mM AQDS-(NH₄)₂ on a double-layer electrode in the absence (i) and presence (ii) of FePO₄. The insets illustrate the double-layer electrode structure.

FIG. 8 depicts the concentration change of BSP-Fc+ at different durations of reaction with excessive FePO₄.

FIG. 9 depicts the FT-IR spectra of the samples which were collected from the tanks after the electrochemical insert Li⁺ and that of commercial LiFePO₄.

FIG. 10 depicts (a) CVs of Li₃[Fe(CN)₆] and LiFePO₄ powder in 0.5 M Li₂SO₄ solution. (b) Voltage profile of oxidative leaching of Li⁺ from LiFePO₄ in an electrolytic flow cell paired with hydrogen evolution reaction (HER) reaction in the counter electrode at a constant current of 50 mA cm⁻¹.

FIG. 11 depicts the FTIR spectra of the samples collected from the tanks and commercial LiOH·H₂O.

FIG. 12 depicts (a) voltage profile of reductive leaching of LCO in an electrolytic flow cell paired with OER reaction in the counter electrode at a constant current of 10 mA cm⁻². (b) Voltage profile of reductive removal of lithium from the electrolyte after cobalt removal by FePO₄ in an electrolytic flow cell paired with OER reaction in the counter electrode at a constant current of 10 mA cm⁻². (c) Voltage profile of oxidative leaching of LiFePO₄ obtained from lithium insertion in previous step in an electrolytic flow cell paired with HER reaction in the counter electrode at a constant current of 10 mA cm⁻².

FIG. 13 depicts the voltage profile of reductive leaching of NMC (NMC811; LiNi_{0.85}Mn_{0.1}Co_{0.1}O₂) in an electrolytic flow cell paired with OER reaction in the counter electrode at a constant current of 10 mA cm⁻² without catalyst.

FIG. 14 depicts the flow chart of the reductive leaching of LCO and concurrent removal of Co²⁺ and Li⁺. AEM: anion exchange membrane.

FIG. 15 depicts CV curves for 5 mM Fc-SO₃Li and AQDS-2NH₄ in 50 mM H₂SO₄ solution on the glassy carbon electrode. The scan rate was 50 mV/s.

FIG. 16 depicts the voltage profile of reductive leaching of LCO in an electrolytic flow cell using Fc-SO₃⁻ as RM₁. The current density was 50 mA/cm².

FIG. 17 depicts the XRD pattern of the obtained Co(OH)₂ precipitate.

FIG. 18 depicts (a) voltage profile of FePO₄ reduction and Li⁺ insertion in an electrolytic flow cell using Fc-SO₃⁻ as RM₁. The current density was 50 mA/cm². (b) XRD pattern of the obtained LFP after Li⁺ insertion.

FIG. 19 depicts (a) voltage profile of oxidative leaching of LFP in an electrolytic flow cell using [Fe(CN)₆]^{3-/4-} as RM₂. The current density was 50 mA/cm². (b) XRD pattern of the obtained FP after leaching of lithium.

### DESCRIPTION

The current invention relates to a high-throughput electrolytic flow cell system to continuously break down the spent lithium-ion battery (LIB) materials into valuable chemicals at ambient conditions, without consuming additional chemicals. As such, the invention relates to electrolytic devices and to a method of recycling a spent battery material.

Thus, in a first aspect of the invention, there is provided an electrolytic device comprising:
an electrolyser, which comprises a first cathode compartment comprising a cathode, a first anode compartment comprising an anode and a cation exchange membrane separating the first cathode and the first anode compartments from one another;
a first to third cathode tank, where:
   the first cathode tank is fluidly connected to at least the cathode compartment and to the second cathode tank;
   the second cathode tank is fluidly connected to at least the first cathode tank and to the third cathode tank and can accept LiOH;
   the third cathode tank is fluidly connected to at least the first cathode tank, the second cathode tank and the first cathode compartment; and
an anode tank fluidly connected to the first anode compartment, wherein:
each of the first and second cathode tanks can be independently selected to be fluidly connected to the cathode compartment at any given time;
the first cathode tank is configured to accept a spent battery material and an electrolyte and supply a liquid to the second cathode tank;
the second cathode tank is configured to accept a liquid from the first cathode tank and to accept LiOH in solid and/or liquid form, and supply a liquid the third cathode tank; and
the third cathode tank is configured to accept a liquid from the second cathode tank.

In a second aspect of the invention, there is provided an electrolytic device comprising:
a first electrolyser, which comprises a first cathode compartment comprising a cathode, a first anode compartment comprising an anode and a cation exchange membrane separating the first cathode and the first anode compartments from one another;
a second electrolyser, which comprises a second cathode compartment comprising a cathode, a second anode compartment comprising an anode and a cation exchange membrane separating the first cathode and the first anode compartments from one another;
a first anode tank fluidly connected to the first anode compartment;
a second anode tank fluidly connected to the second anode compartment;
a first cathode tank fluidly connected to the first cathode compartment;
a second cathode tank fluidly connected to the second cathode compartment;
a third cathode tank fluidly connected to the first cathode tank and the second cathode tank.

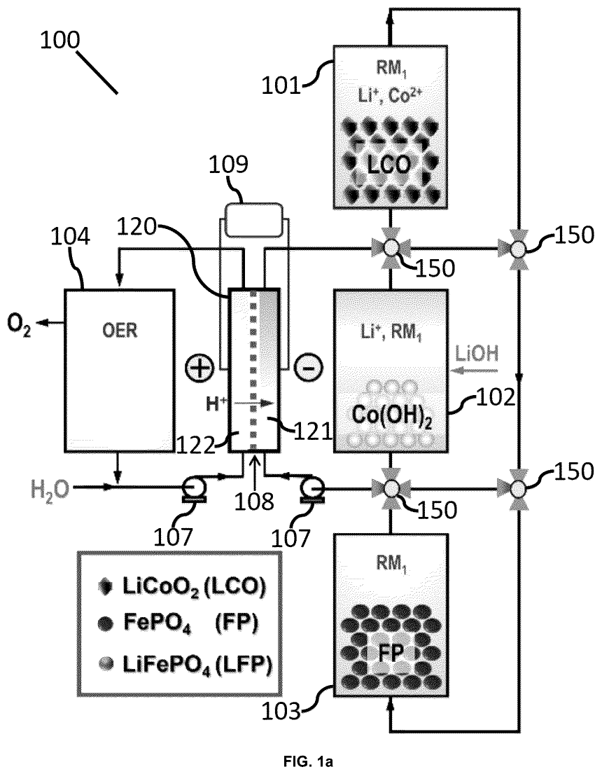

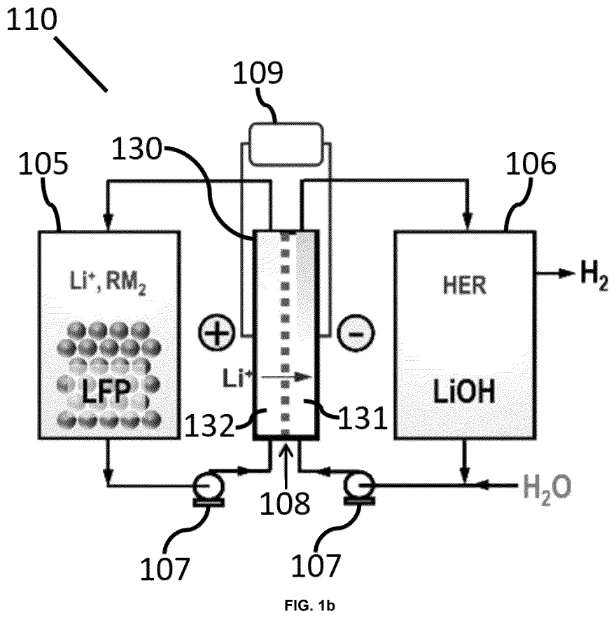

Reference numerals in the above two aspects of the invention refer to the reference numerals in FIG. 1. For convenience, alternative arrangements of the device have the same reference numbers.

The first and second aspects of the invention may be used in combination to provide a closed-loop method of recycling a spent battery material.

In embodiments herein, the word “comprising” may be interpreted as requiring the features mentioned, but not limiting the presence of other features. Alternatively, the word “comprising” may also relate to the situation where only the components/features listed are intended to be present (e.g. the word “comprising” may be replaced by the phrases “consists of” or “consists essentially of”). It is explicitly contemplated that both the broader and narrower interpretations can be applied to all aspects and embodiments of the present invention. In other words, the word “comprising” and synonyms thereof may be replaced by the phrase “consisting of” or the phrase “consists essentially of” or synonyms thereof and vice versa.

The phrase, “consists essentially of” and its pseudonyms may be interpreted herein to refer to a material where minor impurities may be present. For example, the material may be greater than or equal to 90% pure, such as greater than 95% pure, such as greater than 97% pure, such as greater than 99% pure, such as greater than 99.9% pure, such as greater than 99.99% pure, such as greater than 99.999% pure, such as 100% pure.

As used herein, the singular forms “a,” “an,” and “the” include plural referents unless the context clearly dictates otherwise. Thus, for example, reference to “a composition” includes mixtures of two or more such compositions, reference to “a redox mediator” includes mixtures of two or more such redox mediators, and the like.

As such in a third aspect of the invention, there is provided a method of recycling a spent battery material, the method comprising the steps of:
(a) providing a first reaction compartment fluidly connected to a cathode side of an electrolyser that comprises a cathode compartment comprising a cathode, an anode compartment comprising an anode, and a cation exchange membrane separating the cathode and the anode compartments from one another, where an anode side of the electrolyser is set up to generate protons via an oxygen evolution reaction or a hydrogen oxidation reaction, where in an initial state the first reaction compartment comprises:
   a solid spent battery material comprising LiCoO₂ and/or LiNiₓMn_{y}Co_{z}O₂; and an acidic electrolyte comprising a first redox mediator capable of being reduced on the cathode, and
   during a first reductive loop, the acidic electrolyte from the first reaction compartment is provided to the first cathode compartment to provide a reduced first redox mediator and the acidic electrolyte is returned to the first reaction compartment where the reduced redox mediator reacts with the solid spent battery material producing soluble Li⁺, Co²⁺ and, when present, Ni²⁺ and Mn²⁺ ions, while the reduced first redox mediator is oxidised back to its original form and protons are supplied from the anode compartment via the cation exchange membrane,
   during subsequent reductive loops, the acidic electrolyte from the first reaction compartment comprises the first redox mediator, and Li⁺, Co²⁺ and, when present, Ni²⁺ and Mn²⁺ ions,
   the subsequent reaction loops are continued until the Li, Co and, when present, Ni and Mn have been dissolved from the solid spent battery material, whereupon the acidic electrolyte comprising the first redox mediator, and Li⁺, Co²⁺ and, when present, Ni²⁺ and Mn²⁺ ions is supplied to a second reaction compartment;
(b) in the second reaction compartment, the acidic electrolyte comprising the first redox mediator, and Li⁺, Co²⁺ and, when present, Ni²⁺ and Mn²⁺ ions, LiOH is added to precipitate the Co²⁺ and, when present, Ni²⁺ and Mn²⁺ ions to provide a filtered alkaline electrolyte solution comprising the first redox mediator, and Li⁺, which is supplied to a third reaction compartment when the Co²⁺ and, when present, Ni²⁺ and Mn²⁺ ions are substantially or are entirely removed from the filtered alkaline electrolyte solution by precipitation;
(c) in an initial state, the reaction compartment houses FePO₄ and accepts the filtered alkaline electrolyte solution from the second reaction compartment,
   during a first reaction loop, the filtered alkaline electrolyte is supplied from the third reaction compartment to the cathode compartment to provide an electrolyte comprising a reduced first redox mediator and Li⁺ ions and the electrolyte is returned to the third reaction compartment where the reduced redox mediator reacts with the FePO₄ producing LiFePO₄ and the reduced first redox mediator is oxidised back to its original form and protons are supplied from the anode compartment via the cation exchange membrane,
   during subsequent reaction loops, the electrolyte from the third reaction compartment comprises the first redox mediator, and a reduced concentration of Li⁺ ions,
   the subsequent reaction loops are continued until the Li⁺ ions are substantially or are entirely removed from the electrolyte, such that the electrolyte matches, or substantially matches, the acidic electrolyte of step (b), at which point the LiFePO₄ and any remaining FePO₄ are harvested.

As will be appreciated, the method disclosed above may make use of the device of the first aspect of the invention. It will also be appreciated that the above method allows the recovery of lithium (and other metals) from the battery in a form that may be readily recovered. For example, embodiments of the invention, the method may further comprise the steps of:
(i) providing a fourth reaction compartment fluidly connected to an anode side of an electrolyser that comprises an anode compartment comprising an anode, a cathode compartment comprising cathode, and a cation exchange membrane separating the cathode and the anode compartments from one another, where the cathode side of the electrolyser is set up to generate hydrogen gas and hydroxide ions via a hydrogen evolution reaction, the cathode compartment being fluidly connected to a storage tank, where in an initial state the fourth reaction compartment comprises:
   the fourth reaction compartment the LiFePO₄ and any remaining FePO₄ harvested from step (d) above and an electrolyte comprising a second redox mediator capable of being oxidised on the anode; and
   the storage tank comprises water,
      during a first reaction loop, the electrolyte from the fourth reaction compartment is provided to the anode compartment to provide an oxidised second redox mediator and the electrolyte is returned to the fourth reaction compartment where the oxidised redox mediator reacts with the LiFePO₄ to provide FePO₄ and Li⁺ ions,
      during subsequent reaction loops the electrolyte comprising the redox mediator and Li⁺ ions is supplied to the anode compartment, where:
         the redox mediator is converted into an oxidised redox mediator; and
         at least some of the Li⁺ ions are transported through the cation exchange membrane into the cathode compartment and hence to the storage tank,
      the subsequent reaction loops are continued until the LiFePO₄ is substantially or entirely consumed and the storage tank comprises aqueous lithium hydroxide solution.

In embodiments of the invention, the first redox mediator may be any suitable material. For example, the first redox mediator may have a redox potential lower than LiCoO₂ and/or LiNiₓMn_{y}Co_{z}O₂. In particular embodiments of the invention, the first redox mediator may have a redox potential of less than 0.4 V vs standard hydrogen electrode (SHE), such as from 0.05 to 0.39 V vs SHE, such as about 0.23 V vs SHE or about 0.31 V vs SHE. In yet more particular embodiments of the invention, the first redox mediator may be one or both of Fe—SO₃Li and AQDS-2NH₄.

The first redox mediator may be present in any suitable concentration in the acidic electrolyte. For example, the first mediator may have a concentration of from 1 to 100 mM in the acidic electrolyte, such as from 2 to 50 mM, such as about 40 mM or about 5 mM.

The acidic electrolyte may be formed from water and an acidic compound (for the avoidance of doubt, this may be one or more acidic compounds). The acidic compound may be an organic acid or it may be a mineral acid. In particular embodiments of the invention, the acidic compound may be sulphuric acid and/or acetic acid. Any suitable concentration of the acidic compound may be used in embodiments herein. For example, the acidic compound may have a concentration of from 0.2 M to 5 M, such as from about 0.4 M to 3 M.

The second redox mediator may be any suitable material that can conduct the functions mentioned here. For example, the first redox mediator may have a redox potential lower than LiFePO₄. In particular embodiments of the invention, the second redox mediator may be Li₃[Fe(CN₆).

As noted herein, the method described herein may be operated in a closed-loop fashion.

The method and devices mentioned herein will now be described in more detail by reference to the drawings.

FIG. 1a depicts an electrolytic device 100 that may be used to strip metals from a spent lithium battery material and provide said metals in forms that may be easily removed from the device for further processing if desired. FIG. 1b depicts an electrolytic device 110 that can be used to obtain aqueous lithium hydroxide from end products obtained from the device of FIG. 1a.

The electrolytic device 100 of FIG. 1a is one possible arrangement of components that may be used to obtain metals in a form suitable for further processing or use from a spent lithium battery material. This device comprises an electrolyser 120, which comprises a first cathode compartment 121 comprising a cathode, a first anode compartment 122 comprising an anode and a cation exchange membrane 108 separating the first cathode and the first anode compartments from one another. Attached to the electrolyser on the cathode compartment side are a first 101, second 102, and third 103 cathode tanks. Each of these tanks may be fluidly connectable to the electrolyser 120 if desired, and to each other. The fluid connections between the tanks and the electrolyser may be controlled by one or more valves 150. Any suitable valve may be used herein. In particular embodiments that may be mentioned herein:
the first cathode tank 101 may be fluidly connected the cathode compartment and to the second cathode tank;
the second cathode tank 102 may be fluidly connected to the first cathode tank 101 and to the third cathode tank 103 and can accept LiOH;
the third cathode tank 103 may be fluidly connected to the first cathode tank 101, the second cathode tank 102 and the first cathode compartment 121. The first anode compartment 122 is fluidly connected to an anode tank 104. The device also includes suitable fluid connections, valves and pumps 107. The first 101 and third 103 cathode tanks can be independently selected to be fluidly connected to the first cathode compartment 120 at any given time. The first cathode tank is configured to accept a spent battery material and an electrolyte and supply a liquid to the second cathode tank. The second cathode tank is configured to accept a liquid from the first cathode tank and to accept LiOH in solid and/or liquid form, and supply a liquid the third cathode tank. The third cathode tank is configured to accept a liquid from the second cathode tank. In use, the electrolytic device 100 will be connected to a power supply 109 via the anode and cathode.

The electrolytic device 110 of FIG. 1b is intended to convert a solid-storage form of the lithium obtained from the device of FIG. 1a and provide aqueous lithium hydroxide. As such, the device 110 has a cathode compartment 131 comprising a cathode, an anode compartment 132 comprising an anode and a cation exchange membrane 108 separating the cathode and the anode compartments from one another. Attached to the electrolyser on the cathode compartment side is a cathode tank 106, which is in fluid communication with the cathode compartment. Attached to the electrolyser on the anode compartment side is an anode tank 105, which is in fluid communication with the cathode compartment. The device also includes suitable fluid connections, valves and pumps 107. The device is configured to receive a solid material from the device of FIG. 1a in the anode tank and is configured to collect LiOH in the cathode tank. In use, the electrolytic device 100 will be connected to a power supply 109 via the anode and cathode.

The devices of FIGS. 1a and 1b may be used as follows to recover lithium and other metals (if present) from a spent battery material. Referring initially to FIG. 1a.

Process 1: Reductive leaching of spent battery materials (e.g. using LiCoO₂ (LCO)).
(1) The electrolyzer 120 is fluidly connected to cathode tank 101 and anode tank 104.
(2) Cathode tank 101 houses the spent battery material (e.g. LCO), an acidic electrolyte and a redox mediator 1 (RM₁). The electrolyte (containing RM₁) is provided to the cathode compartment 121, where RM₁ is reduced to RM₁⁻ on the cathode.
(3) The electrolyte solution containing RM₁⁻ is returned to cathode tank 101. When RM₁⁻ contacts LCO, it is oxidised back to RM₁ and the LCO is reduced. Under acidic conditions (pH=0-3), the reduced oxide material gradually dissolves into Li⁺, Co₂⁺ ions in the electrolyte solution.
(4) The electrolyte solution containing RM₁ is pumped back to the cathode compartment where it is reduced back to RM₁⁻ for the next round of reaction.
(5) On the anodic side, an oxygen evolution (OER) reaction may be employed with the supply of water from the anode tank 104. The OER produces protons.
(6) The generated protons pass through the cation-exchange membrane 108 into the cathode compartment 121. As such, the pH of the electrolyte solution will change over time due to the introduction of more protons from the anode compartment into the cathode compartment.
(7) The steps above are continuously run until the LCO has been entirely dissolved, at which the pH will be <3.
(8) The remaining undissolved impurity is removed from cathode tank 101.

Process 2: Removal of Co₂⁺ by precipitation
(1) After the process 1 is complete, the dissolved LCO together with the electrolyte solution, which contains Li⁺, Co₂⁺, RM₁ and supporting electrolyte, is provided to cathode tank 102.
(2) In tank 102, LiOH is added, with which Co₂⁺ forms Co(OH)₂ and precipitates. The precipitated Co(OH)₂ can then be separated from the electrolyte solution. It is noted that when the pH of the solution is higher than 10, Co₂⁺ can be removed nearly entirely.
(3) The resulting filtered electrolyte solution, which now contains Li⁺ and RM₁, flows into cathode tank 103.

Process 3: Electrochemical Removal of Li⁺
(1) The electrolyzer 120 is fluidly connected to cathode tank 103 and anode tank 104.
(2) In cathode tank 103, FePO₄ (FP) is pre-loaded.
(3) The filtered electrolyte solution from process 2 flows back to the cathodic compartment 121 of electrolyzer 120 and RM₁ is reduced to RM₁⁻ on the cathode.
(4) The electrolyte solution containing Li⁺ and RM₁⁻ flows into cathode tank 103, in which the RM₁⁻ reduces FP and is itself is oxidized back to RM₁. The reduction of FP involves the insertion of Li⁺ forming LiFePO₄ (LFP).
(5) The electrolyte solution containing RM₁ is pumped back to the cathode compartment where it is reduced back to RM₁⁻ for the next round of reaction.
(6) On the anodic side, an oxygen evolution (OER) reaction may be employed with the supply of water from the anode tank 104. The OER produces protons.
(7) The generated protons pass through the cation-exchange membrane 108 into the cathode compartment 121, thereby reducing the pH of the electrolyte (which is initially basic (e.g. pH 10)) over time.
(8) The above steps proceed continuously to achieve removal of Li⁺ (both the Li⁺ ions from LCO in process 1 and from LiOH in process 2).
(9) At this point, the pH and composition of the electrolyte solution recover to match (or substantially match) that used in process 1 (1).
(10) The solid LFP may then be removed from cathode tank 103.

Referring to FIG. 1B.

Process 4: Oxidative Leaching and Separation of Li⁺
(1) This step involves electrolyzer 130, paired with cathode tank 106 and anode tank 105.
(2) The LFP obtained in process 3 is transferred into anode tank 105.
(3) On the anodic side, redox mediator 2 (RM₂) in the anodic electrolyte solution are firstly oxidized to RM₂⁺ on the anode in the anode compartment 132.
(4) The electrolyte solution including RM₂⁺ flows into anode tank 105, where it oxidizes LFP and is itself reduced back to RM₂. The oxidation of LFP involves the extraction of Li⁺ ions, thereby forming FP.
(5) The electrolyte solution including RM₂ and Li⁺ is pumped back to the anode compartment where it is oxidized back to RM₂⁺ for the next round of reaction.
(6) Li⁺ ions in the electrolyte solution are transported to the cathode compartment 131 through the cation-exchange membrane 108.
(7) On the cathodic side, a hydrogen evolution (HER) reaction occurs with the supply of water, which produces H₂ and OH⁻. The concentration of LiOH in catholyte in tank 105 gradually increases.
(8) These reactions are allowed to proceed continuously to achieve a complete (or almost complete) extraction of Li⁺ from LFP in tank 105.
(9) The resulting FP in tank 105 may be used again in process 3 for the removal of Li⁺. And part of the produced LiOH may be used in process 2 for the removal of Co₂⁺.

With the above complementary and close-loop reactions, the entire recycling process of LCO only requires the supply of water and electricity. Note that the OER reaction in electrolyzer 120 can be replaced by a hydrogen oxidation reaction (HOR) reaction with the supply of H₂ produced from electrolyzer 130. This would allow the method to operate with no waste (except the impurity in the spent LCO black mass, i.e., carbon black, binder, etc.), and the electricity consumption could be further reduced. In the end, the spent LCO is broken down to battery grade LiOH and Co(OH)₂. It is noted that other metals used in lithium ion batteries may be recovered along with Co as precipitants in process 2 above.

An alternative arrangement for a device that may be used from processes 1 to 3 above is depicted in FIG. 14. In this device, there are two separate electrolysers 120 and 140. Electrolyser 120 is intended to be fluidly connected to cathode tank 101 and anode tank 104. Electrolyser 140 is intended to be connected to cathode tank 103 and anode tank 145. As depicted, cathode tank 102 in this device is only fluidly connected to cathode tanks 101 and 103. Due to the presence of valves and pumps, it will be appreciated that this device may be operated in an analogous manner to that depicted in FIG. 1a. In which case, one of the anode tanks and electrolysers are not used (i.e. anode tank 104 and electrolyser 120 or anode tank 145 and electrolyser 140). However, all of the tanks may be used and this is now discussed in more detail below.

Process 1: Reductive leaching of spent battery materials (e.g. using LiCoO₂ (LCO)).

This process operates in the same way as discussed before, where cathode tank 101 and anode tank 104 are fluidly connected to electrolyser 120.

Process 2: Removal of Co₂⁺ by Precipitation
(1) After process 1 is complete, the dissolved LCO together with the electrolyte solution, which contains Li⁺, Co₂⁺, RM₁ and supporting electrolyte, is provided to cathode tank 102.
(2) In tank 102, LiOH is added, with which Co₂⁺ forms Co(OH)₂ and precipitates. The precipitated Co(OH)₂ can then be separated from the electrolyte solution. It is noted that when the pH of the solution is higher than 10, Co₂⁺ can be removed nearly entirely.
(3) The resulting filtered electrolyte solution, which now contains Li⁺ and RM₁, flows into cathode tank 103.

Process 3: Electrochemical removal of Li⁺

This process operates in the same way as discussed before, where cathode tank 103 and anode tank 145 are fluidly connected to electrolyser 140.

As will be appreciated, this device and process flow may make it easier to continuously operate processes 1 to 3, thereby improving he efficiency and throughput of the system.

The LFP obtained from process 3 of FIG. 14 may then be subjected to process 4 (using the device of FIG. 1b) to provide LiOH.

Further details of the operation of the devices and the methods may be found in the examples section below.

The use of redox mediators as a reducing agent to continuously leach spent LiCoO₂ and NMC materials means that the reducing agents can be regenerated through an electrochemical process, with no need for additional chemicals to be added to the system. When this is combined with the oxidation reaction for leaching lithium, a complete closed-loop process is formed, meaning that all of the chemicals used in the process can be regenerated, with water as the only chemical consumable. This reduces the consumption of chemical reagents and thereby reduces the environmental impact of the method.

The processes outlined here allows for the complete separation of different metal ions. As shown in the embodiments above, and in the examples below, lithium and cobalt ions can be completely separated from one another, with high purity products formed.

As will be appreciated, the process above is agnostic to whether the spent battery material (i.e. spent active material) is obtained from a cathode and/or an anode. This is because the process can work for active materials of both types, though there may be a preference for cathode active materials.

As will be appreciated, the process described above relate to the recovery of lithium from spent (retired) batteries or from waste materials produced during the manufacturing process. As such, the active materials referred to above may not be capable of functioning in a battery in their current form and so there is a need to recover the lithium and other valuable elements for reuse.

The cation exchange membrane divides the cathode compartment from the anode compartment. It can be an electro-active ion conducting membrane (e.g., a proton or a lithium ion conducting membrane). The cation exchange membrane prevents cross-diffusion of the redox mediator and allows for movement of the electro-active ions (e.g., potassium ions, or, more particularly, protons, lithium ions, sodium ions, magnesium ions, aluminum ions, silver ions, copper ions, protons, or a combination thereof; more particularly, the electro-active ions may be potassium ions, or, more particularly, protons, lithium ions, sodium ions, magnesium ions, aluminum ions, copper ions, protons, or a combination thereof). For example, the cation exchange membrane may be a lithium phosphorus oxynitride glass, a lithium thiophosphate glass, sodium phosphorus oxynitride glass, a sodium thiophosphate glass, a NASICON-type lithium conducting glass ceramic, a NASICON-type sodium conducting glass ceramic, a Garnet-type lithium or sodium conducting glass ceramic, a ceramic nanofiltration membrane, a lithium or sodium ion-exchange membrane, or suitable combinations thereof.

The electrodes in the apparatus, i.e., the cathodes and the anodes, can be a carbon, a metal, or a combination thereof. Preferably, these two electrodes have high surface area, with or without one or more catalysts, to facilitate the charge collection process. They can be made of a carbon, a metal, or a combination thereof. Examples of an electrode can be found in Skyllas-Kazacos, et. al., Journal of The Electrochemical Society, 158, R55-79 (2011) and Weber, et. al., Journal of Applied Electrochemistry, 41, 1137-64 (2011).

The cathodic active material may come from a depleted (retired) battery or from the manufacturing processes to manufacture such batteries. Any form of the cathodic active material may be used. For example, the cathodic active material may still be attached to a cathode electrode of a dismantled lithium-or sodium-ion battery or is provided free from the cathode electrode.

Examples of cathodic active materials include, but are not limited to, LiCoO₂ and/or LiNiₓMn_{y}CO_{z}O₂, and combinations thereof.

A redox mediator refers to a compound present (e.g., dissolved) in the solvent placed in the same tank (i.e. first tank) as the active material that acts as a molecular shuttle to transport the lithium to the electrode in the flow cell to which the tank is connected.

The process for recovering anodic active material is analogous to the process described hereinbefore for the recovery of cathodic active materials.

While the process described herein make use of only a cathodic or anodic active materials separately, it will be appreciated that the same process as described above may be run for a combination of the cathodic and anodic active materials.

Further aspects and embodiments of the invention will now be discussed by reference to the following non-limiting examples.

### EXAMPLES

### Materials

All the chemicals and reagents were purchased from commercial suppliers and used without any purification unless otherwise mentioned. Anthraquinone-2,7-disulfonate sodium salt was purchased from Zhengzhou Alfa Chemical Co., Ltd. Battery grade LiFePO₄ powder was purchased from Li-cell Co. company. Reagent grade LiOH·H₂O (99.5%), K₃Fe(CN)₆ (99.0%), Fe₄[Fe(CN)₆]₃ (99.3%) and LiCoO₂ were purchased from Sigma Aldrich without further purification. Nafion 212 membrane was purchased from Dupont and used directly. Co(NO₃)₂, Ce(NO₃)₃, AlCl₃, CH₂Cl₂, NaBH₄, diglyme, EtOH, amberlite cation exchange resin, polyvinylidene fluoride (PVDF), N-methyl-2-pyrrolidone (NMP), and ammonium hydroxide were purchased from Sigma Aldrich. NMC811 was purchased from Beyond Battery Pte Ltd.

All the reactions were carried out in flame-dried glassware under nitrogen atmosphere.

### Analytical Techniques

### Nuclear Magnetic Resonance (NMR) Spectroscopy

¹H spectra was recorded on Bruker 500 MHz spectrometers. The NMR spectra were recorded in solutions of deuterated dimethyl sulfoxide (DMSO-d₆) with residual DMSO (2.50 ppm for ¹H-NMR) taken as the internal standard, and deuterium oxide (D₂O) with D₂O (4.79 ppm for ¹H-NMR) taken as the internal standard. Data are presented as chemical shift parts per million (δ).

### XRD

XRD measurements were performed with a Powder XRD Diffractometer System (Bruker D8, Cu Kα radiation).

Inductively Coupled Plasma Optical Emission spectroscopy (ICP-OES)

ICP-OES was conducted at the elemental analysis lab in NUS chemistry department.

### FT-IR Spectroscopy

FTIR measurement was performed a PerkinElmer Frontier MIR/FIR system with the attenuated total reflection (ATR) mode to confirm the structure of collected Co(OH)₂ and LiOH powders. The FTIR spectra were collected from 4000 to 400 cm⁻¹ for Co(OH)₂ and 4000 to 500 cm⁻¹ for LiOH respectively, with 4 cm⁻¹ resolution.

### General Procedure for Synthesizing anthraquinone-2,7-disulfonate di-Ammonium Salt

Anthraquinone-2,7-disulfonate di-ammonium salt was synthesized using the following methods. AQDS-2Na was first changed to AQDS acid by dissolving it in deionized water and was flushed over a cation exchange column with Amberlite cation exchange resin (IR-120 hydrogen form). After removing water with a rotary evaporator and drying in a vacuum oven at 60° C. for 24 h, yellow AQDS solid acid was obtained. AQDS acid was then dissolved in deionized water and cooled by ice bath. 30% ammonium hydroxide was added to convert the acid to ammonium salt. After water was removed with a rotary evaporator, the wet solid residue was dried in a vacuum oven at 60° C. for 24 h. The final product AQDS-2NH₄ was collected as dark brown solid.

### Example 1. Synthesis of 1,1′ bis(propyl lithium sulphite) ferrocene (BSP-Fc)

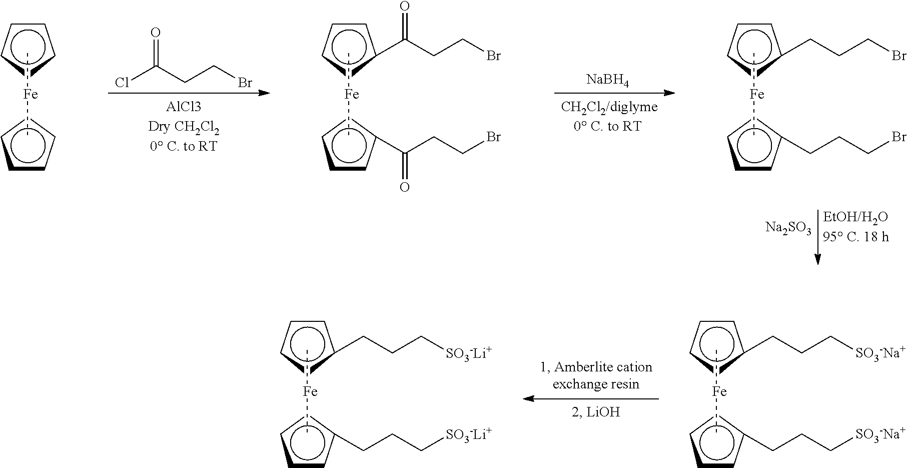

The 1,1′ bis-(propyl lithium sulphite) ferrocene was obtained by ion exchange with 1,1′ bis(propyl sodium sulphite) ferrocene (J. Yu et al., Energy Storage Mater. 2020, 29, 216-222). 1,1′ bis (propyl sodium sulphite) ferrocene (2 g, 4.22 mmol) was dissolved in deionized water (5 mL) and flushed over a cation exchange column with Amberlite cation exchange resin (IR −120 hydrogen form). The obtained solution was cooled down by an ice bath. Then, LiOH·H₂O (0.18 g, 4.28 mmol) was added to convert the acid to the lithium salt. After the water was removed by a rotary evaporator, the precipitated solid was dried in a vacuum oven.

¹H NMR (500 MHZ, DMSO-d₆): δ 4.21-4.18 (m, 8H), 2.95-2.92 (m, 4H), 2.46 (t, 4H, J=4.6 Hz), 1.97-1.91 (m, 4H).

### Example 2. Chemical and Electrochemical Synthesis of Li₄[Fe(CN)₆] and Li₃[Fe(CN)₆]

Li₄[Fe(CN)₆] was synthesized by immersing 5.0 g of Fe₄[Fe(CN)₆] powder into 60 mL of 1 M LiOH·H₂O (3.08 g, 73.3 mmol) solution with deionized water as solvent. After 10 h of reaction at room temperature, a yellowish Li₄[Fe(CN)₆] solution was obtained after removing the brown Fe(OH)₃ precipitate by filtration (as shown in equation (1)). Then, the solvent was removed under reduced pressure and the obtained crude product was washed with ethanol. The filtered solid was heated in a vacuum oven at 60° C. for 24 hours. Light yellow crystal particles were obtained. A solution of Li₃Fe(CN)₆ was prepared by electrolysing Li₄Fe(CN)₆ solution. Hydrogen evolution reaction (HER) took place on the counter electrode (cathode) with 0.5 M Li₂SO₄ solution as the supporting electrolyte. Carbon felt (5 cm²) was used as the anodic and cathodic electrode in the flow battery cell.

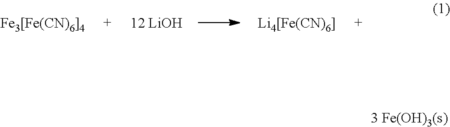

### Example 3. Synthesis of OER Catalyst

The OER catalyst was synthesized according to the reference (Huang, J. et al., Nat. Commun. 2021, 12, 3036). Firstly, the Ce(OH)₃-doped Co(OH)₂ was synthesized by electrodeposition with 0.09 mol Co(NO₃)₂ and 0.01 mol Ce(NO₃)₃ as the electrolyte. During the electrodeposition, a constant potential of −1.0 V vs. Ag/AgCl was applied on the substrates for 10 min in the case of carbon paper with Pt mesh as the counter electrode (the as-received carbon paper substrate (Fuel Cell Store, Sigracet 39 AA) was Teflon-coated; before use, it was first annealed in air at 400° C. for 10 h to make the surface hydrophilic.). After electrodeposition, the obtained metal hydroxide precursor was dried at 60° C. in a vacuum oven and then annealed in air at 400° C. for 2 h in a muffle furnace to transform into oxides.

### Example 4. Closed-Loop Spent LCO Battery Recycling System (Path 1)

According to the mechanism of redox-targeting, when the redox potential of the mediator molecule and the solid active material are different, the potential difference provides the driving force for the reaction between them. When the potential of the mediator molecule is higher than the solid active material, the mediator molecule is reduced, and then it is pumped to the anode for charging and returns to the initial state, then enters the next cycle. The reverse case occurs when the mediator has a lower potential, which can continuously reduce the solid materials. The mediator as the charge carrier connects the electrode with the solid active materials, thus the continuous transfer of electrons from the electrode to the uncontacted active material is realized. A prior study realized the efficient recycling of lithium ions via redox targeting reactions of the spent lithium iron phosphate (LFP) batteries by oxidative leaching (J. Yu et al., Energy Environ. Sci. 2019, 12, 2672-2677). However, the high redox potential of LCO (up to 1 V higher) makes the oxidative leaching approach used for LFP nearly impossible, since redox mediators could hardly survive and may induce water decomposition. Therefore, a shift from oxidative leaching to reductive leaching is proposed as an effective and implementable means for the recycling of oxide materials.

Here, we propose a novel high-throughput electrolytic flow cell system to continuously break down the spent battery materials into valuable chemicals at ambient conditions, combined with chemical process to separate and recover cobalt and lithium ions with high yield and purity, without consuming additional chemicals.

A closed-loop spent LCO battery recycling system integrating redox-targeting-based electrochemical and chemical processes is shown in FIG. 1. As depicted in FIG. 1, the device 100 includes tank I 101, tank II 103, tank III 102, tank IV 104, tank V 105, tank VI 106, pumps 107, cation exchange membranes 108, and power supply 109. With reference to FIG. 1, tank I (101) includes reductive leaching of LCO, tank II (103) includes reductive removal of Li⁺, tank III (102) includes removal of Co²⁺ by precipitation, tank IV (104) includes OER or HOR (acidic), tank V (105) includes oxidative leaching of LFP, and tank VI (106) includes HER or oxygen reduction reaction (ORR) (alkaline). The closed-loop process route is I/IV→III→II/IV→V/VI.

The closed-loop, complementary recycling process of spent battery materials could be implemented in different ways.

Path 1: The flow chart in FIG. 1 illustrates the recycling process from the reductive leaching of spent lithium battery materials, stepwise separation of respective components, to recovery of the metal species. The detailed operations are described below.

Step 1: Reductive leaching of spent battery materials (with LiCoO₂ or LCO as an example).
(1) This step involves electrolyzer A, paired with reactor tanks I and IV.
(2) On the cathodic side, redox mediator 1 (RM₁) in the acidic electrolyte solution is firstly reduced to RM₁⁻ on the cathode.
(3) The electrolyte solution containing RM₁⁻ flows into tank I, in which it further reduces LCO while itself is oxidized back to RM₁. Under acidic conditions (pH=0-3), the reduced oxide material gradually dissolves into Li⁺ and Co²⁺ in the electrolyte solution.
(4) The electrolyte solution containing RM₁ is pumped back to the cathode compartment where it is reduced back to RM₁⁻ for the next round of reaction.
(5) On the anodic side, an OER reaction occurs with the supply of water, which produces protons.
(6) The generated protons are transported to the cathodic compartment through a cation-exchange membrane.
(7) The whole electrolysis reactions proceed continuously to achieve an entire dissolution of LCO, at which the pH is monitored to be <3.
(8) The remaining undissolved impurity is removed from tank I.

Step 2: Removal of Co²⁺ by precipitation.
(1) After Step 1 is completed, the dissolved LCO, together with the electrolyte solution which contains Li⁺, Co²⁺, RM₁ and supporting electrolyte, flows to tank III.
(2) In tank III, LiOH is added, with which Co²⁺ forms Co(OH)₂ and precipitates. Co(OH)₂ is then separated from the electrolyte solution. When the pH of the solution is higher than 10, Co²⁺ could be removed nearly entirely.
(3) The filtered electrolyte solution which just contains Li⁺ and RM₁ flows into tank II.

Step 3: Electrochemical removal of Li⁺.
(1) This step involves electrolyzer A, paired with reactor tanks II and IV.
(2) In tank II, FePO₄ (FP) is pre-loaded.
(3) The filtered electrolyte solution from Step 2 flows back to the cathodic compartment of electrolyzer A, and RM₁ is reduced to RM₁⁻ on the cathode.
(4) The electrolyte solution containing Li⁺ and RM₁⁻ flows into tank II, in which the RM₁⁻ further reduces FP while itself is oxidized back to RM₁. The reduction of FP involves the insertion of Li⁺, forming LiFePO₄ (LFP).
(5) The electrolyte solution containing RM₁ is pumped back to the cathode compartment where it is reduced back to RM₁⁻ for the next round of reaction.
(6) On the anodic side, an OER reaction occurs with the supply of water, which produces protons.
(7) The generated protons are transported to the cathodic compartment through a cation-exchange membrane. These protons just compensate for the consumption in Step 1.
(8) The whole electrolysis reactions proceed continuously to achieve a complete removal of Li⁺ (those from LCO in Step 1 and from LiOH in Step 2).
(9) At this point, in theory, the pH and composition of the electrolyte solution recover to that at Step 1 (1).
(10) The solid LFP is removed from tank II.

Step 4: Oxidative leaching and separation of Lit.
(1) This step involves electrolyzer B, paired with reactor tanks V and VI.
(2) The LFP obtained in Step 3 is transferred into anodic tank V.
(3) On the anodic side, redox mediator 2 (RM₂) in the anodic electrolyte solution is firstly oxidized to RM₂⁺ on the anode.
(4) The electrolyte solution containing RM₂⁺ flows into tank V, in which it further oxidizes LFP while itself is reduced back to RM₂. The oxidation of LFP involves the extraction of Li⁺, forming FP.
(5) The electrolyte solution containing RM₂ and Li⁺ is pumped back to the anode compartment where it is oxidized back to RM₂⁺ for the next round of reaction.
(6) Li⁺ ions in the electrolyte solution are transported to the cathodic compartment through a cation-exchange membrane.
(7) On the cathodic side, an HER reaction occurs with the supply of water, which produces H₂ and OH⁻. The concentration of LiOH in catholyte in tank VI gradually increases.
(8) The whole electrolysis reactions proceed continuously to achieve a complete extraction of Li⁺ from LFP in tank V.
(9) The resulted FP in tank V could be used again in Step 3 for the removal of Li⁺, and part of the produced LiOH could be used in Step 2 for the removal of Co²⁺.

With the above complementary and closed-loop reactions, the entire recycling process of LCO only requires the supply of water and electricity. Note the OER reaction in electrolyzer A can be replaced by an hydrogen oxidation reaction (HOR) reaction with the supply of H₂ produced from electrolyzer B, with which no additional waste (except the impurity in the spent LCO black mass, i.e. carbon black, binder, etc.) is generated, and the electricity consumption could be further reduced. In the end, the spent LCO is broken down to battery grade LiOH and Co(OH)₂.

Upon operation, instead of oxidizing LCO with a high-potential redox mediator to extract Li⁺ out from the host, a low-potential redox mediator (BSP-Fc (RM₁)) was employed to reduce LiCoO₂ in the presence of protons generated from the counter electrode compartment. To facilitate the later lithium ion removal process, a weak acid is used as the proton source. As a result, insoluble LiCoO₂ is broken down into soluble Li⁺, Co²⁺ ions and H₂O (in tank I). While the redox mediators are regenerated on the electrode paired with oxygen evolution reaction (OER) on the counter electrode (tank IV), the generated protons are transported to the cathodic compartment through the cation-exchange membrane. Then, the soluble Co²⁺ ions could be separated by adding LiOH (from the tank VI) which precipitates as Co(OH)₂ in a separate reactor tank (tank III). The removal of Li⁺ ions from the solution would be accomplished with a complementary reduction reaction of the recycled FP. With the same redox mediator RM₁ which has a potential lower than FP, FP is reduced with the selective insertion of Li⁺ ions from the electrolyte solution via the redox-targeting reaction, which results in the formation of LFP (tank II). In addition, the counter electrode is accompanied by the OER reaction, and the generated protons are transferred to the cathodic compartment, realizing the supplement of proton consumption (Tank IV).

Then, the redox-mediator 2 (Li₃[Fe(CN)₆], RM₂) with a higher redox potential than LFP was used to continuously break down LFP into FP and Li⁺ via a redox-targeting reaction by the oxidation of LFP (in tank V), along with Li⁺ transport through the membrane to the cathodic compartment. Meanwhile, the HER reaction at the counter electrode not only similarly produces OH⁻ for the formation of LiOH (can be used in tank III to precipitate Co(OH)₂), but it also produces high purity H₂ as a valuable by-product (in tank VI). With the above complementary and closed-loop reactions, the spent LCO material is broken down into high purity LiOH and Co(OH)₂ with a green chemical concept.

### Example 5. Reductive Redox Targeting-Based Strategy

Anthraquinone disulfonate derivatives (AQDS-(NH₄)₂) can be used in both the process of reductive decomposition of LCO and reduction of FP, due to its proper potential and robust stability in acid and neutral conditions (J. Yu et al., Energy Storage Mater. 2020, 29, 216-222), so as to realize lithium ions removal from solution though intercalation into solids. Li₃[Fe(CN)₆] was used as the mediator to achieve high-throughput lithium ions recovery with the HER reaction in the counter electrode.

### Cyclic Voltammetry (CV) Measurement

CV measurements were carried out with Autolab electrochemical workstation (Metrohm, PSTA30). A three-electrode cell system was used to test the CV of the solid active materials and the soluble redox mediator; Pt plate and Ag/AgCl were used as the counter and reference electrode, respectively.

LiCoO₂, FePO₄ or LiFePO₄ working electrode was made by coating a slurry containing LiCoO₂ powder, FePO₄ powder or LiFePO₄ powder onto a piece of carbon paper, and drying in a vacuum oven at 60° C. The slurry was prepared by mixing LiCoO₂, LiFePO₄ or FePO₄ powder, carbon black (CB) and polyvinylidene fluoride (PVDF) with N-methyl-2-pyrrolidone (NMP) as solvent (LiCoO₂:CB:PVDF=8:1:1). The supporting electrolyte for CV tests of LiCoO₂, FePO₄ and LiFePO₄ was 0.5 M Li₂SO₄ solution and the CV data were recorded at scan rates of 1 mV s⁻¹, 1 mV s⁻¹, and 2 mV s⁻¹, respectively.

To measure the redox potential of [Fe(CN)₆]⁴⁻/[Fe(CN)₆]³⁻ or Ferrocene derivatives, Li₃Fe(CN)₆ (10 mL, 0.050 M) solution was prepared. 0.5 M Li₂SO₄ was used as the electrolyte, with glassy carbon as the working electrode, and with a scan rate of 10 mV s⁻¹.

### Double-Layer Electrode Preparation

The double-layer electrode was prepared by coating a ITO glass with a 3 μm-thick spacer layer of aluminum oxide (Al₂O₃) nanoparticles separating the LCO layer. The ITO glass was sonicated sequentially in 5% Decon 90 solution, distilled water, and ethanol three times each before coating. The Al₂O₃ paste was coated on the surface of ITO, and then annealed in air with heating at 400° C. for 2 h. After the Al₂O₃ electrodes were cooled to room temperature, a layer of LCO (LCO slurry is composed of 90 wt % LCO and 10 wt % PVDF mixed evenly in NMP) was coated on the Al₂O₃ film. The electrodes were then dried in a vacuum oven at 60° C. for 24 h. FePO₄ electrode was prepared in a similar method.

### Flow Battery Assembly and Electrochemical Test

Nafion 212 was used as the membrane to separate the anodic and cathodic electrode. 1×1 carbon felt or carbon paper was used as the electrode. The electrolyte was pumped through the anodic tank and cell compartment by the peristatic pump via PTFE tubing. The voltage profile was measured with an Arbin battery tester at a constant current density of 50 mA cm⁻¹.

### OCP Measurement

The OCP test was performed with a three-electrode system. Glassy carbon and Ag/AgCl were used as the working and reference electrodes, respectively, to monitor the equilibrium potential of AHDS/AQDS by measuring the OCP with an Autolab electrochemical workstation (Metrohm, PSTA30). FePO₄ (0.75 g) was added into the solution with 20 mL of 50 mM reduced AQDS-(NH₄)₂ (briefly: AHDS). Through the Nernst equation (2), the concentration of generated oxidized AQDS (briefly: AQDS) can be easily calculated:

$${E}_{AQDS / AHDS} = {E}_{AQDS / AHDS}^{0} + \frac{RT}{F} ln \frac{c ( AQDS )}{c ( AHDS )} \qquad ( 2 )$$

Here, E is the OCP of AQDS/AHDS solution upon reacting with FP, E₀ is the formal potential of AQDS (0 V vs. SHE at pH=4), c is the concentration of AQDS/AHDS. The reaction rate constant (k⁰) and electron transfer coefficient (α) between FP and AHDS were determined in terms of the Butler-Volmer equation (3)

$$\frac{i}{AF} = {k}^{0} [ {ce}^{- a \frac{F}{RT} ( E - {E}^{0} )} - ( 0.05 - c ) {e}^{( 1 - a ) \frac{F}{RT} ( E - {E}^{0} )} ] \qquad ( 3 )$$

Here, i is the current, A is the area of electrode, F is the Faradaic constant, R is the gas constant, T is the temperature. The detected current i is approximately the electron transferred from AHDS to FP. Therefore, i could be replaced by the concentration change of AQDS, as shown in equation (4).

$$i = r \cdot V \cdot F = \frac{dc ( AQDS )}{dt} \cdot V \cdot F \qquad ( 4 )$$

Here, r is the rate of redox targeting reaction, Vis the volume of AQDS solution, 20 mL. The effective current can be calculated with the Butler-Volmer relation.

### Results and Discussion

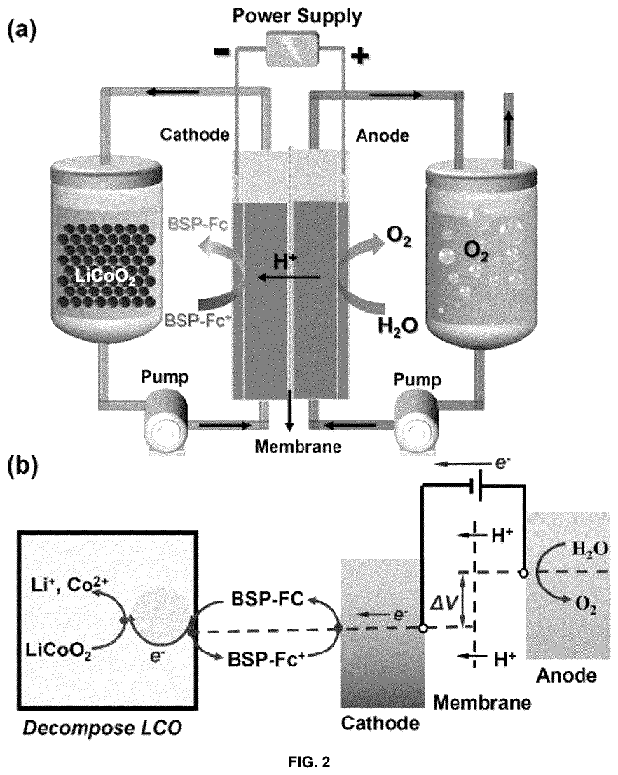

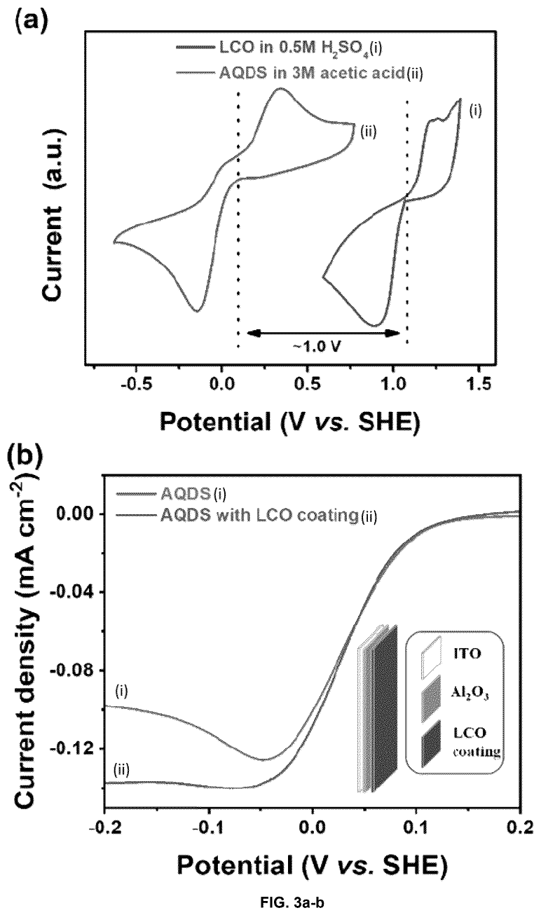

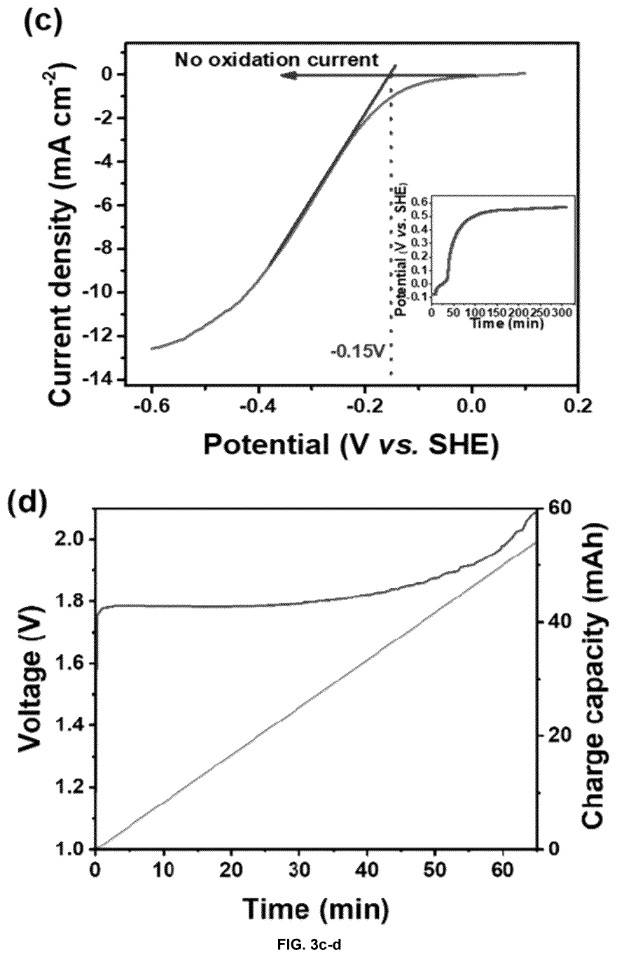

Firstly, the processes of decomposing LCO through reduction and leaching out lithium via redox targeting reactions occur in different tanks which are used as the cathode and anode reaction pools, respectively (FIG. 2). To avoid the influence of other metal ions on the reaction process, AQDS-(NH₄)₂ was used as the redox mediator with lower reductive potential capable of decomposing LiCoO₂ and with good reversibility for prolonged operation in the acid solution. The equilibrium potential difference is the thermodynamic basis for the redox targeting reaction between LCO and AQDS-(NH₄)₂. As determined by CV (FIG. 3a), the equilibrium potential of LCO powder was about 1.07 V versus (vs.) SHE in the 0.5 M H₂SO₄ electrolyte, and the AQDS derivative exhibits excellent stability and fast kinetics in 3 M acetic acid solution at a potential of 0.095 V vs. SHE. Around 1.0 V potential difference would produce a huge driving force to reduce LCO by AQDS.

To verify the redox-targeting reaction that occurs between LCO with AQDS, a double-layer electrode (inset of FIG. 3b) was constructed to simulate the reactions in the tank (M. Zhou et al., Chem 2017, 3, 1036-1049). Because the reductive leaching LCO reaction is an irreversible one-way reaction, the LSV was performed for the proof-of-concept, at first, in a 3 M acetic acid solution containing 5 mM AQDS. A significant reduction peak appeared without LCO coating on the electrode with Al₂O₃ layer. In contrast, the enhanced current density continuously flattened with LCO coating. This indicates that AQDS diffuses to the surface of LCO through the Al₂O₃ layer after accepting the electron from the electrode, and then returns to the surface of the electrode after oxidation by LCO, which leads to the electrode continuously giving out electrons. In other words, the electrochemical reactions of AQDS on the electrode are coupled with its regeneration in the LCO layer in the vicinity.

To examine the reaction kinetics of the redox targeting between AQDS and LCO, the OCP of 50 mM anthrahydraquinone-2,7-disulfonate (AHDS, the reduced form of AQDS) after adding 0.5 g LCO powder (considerable excess) at 25° C. was monitored by potentiometry with a three-electrode device. A rapid increase in OCP was observed from the initial −0.077 V to 0.5 V (vs. SHE) after reaction for 75 min (inset of FIG. 3c), due to the LCO. Due to the dissolution of LCO, the generated Co²⁺ ions lead to the complex reaction system, which makes it impossible to calculate the rate constant. However, from the OCP curve, the rising voltage indicates that the reaction speed between AHDS and LCO is relatively fast. As shown in FIG. 3c, the LSV plot reveals no obvious oxidation current, indicating the almost complete oxidation of AHDS species during the process.

On the basis of the above, to realize the continuous decomposition process of LCO with the AQDS as the redox mediator in acidic condition, an electrochemical flow cell is assembled as shown in FIG. 2a. 50 mM AQDS-(NH₄)₂ solution was fed into the cathode tank with LCO (0.2 g). AQDS-(NH₄)₂ can reduce to AHDS and decompose LCO, accompanied by its oxidation (equation (5)). Then, the AQDS is pumped back to the cathode compartment to be reduced back to AHDS on the surface of the electrode for the next round of reaction (equation (6)). On the anodic side, an OER reaction occurs with the supply of water, which produce protons. The generated protons are transported to the cathodic compartment through a Nafion 212 cation-exchange membrane (equation (7)) for charge balancing. All the electrolysis reactions proceed continuously to achieve an entire dissolution of LCO with the applied voltage (ΔV).

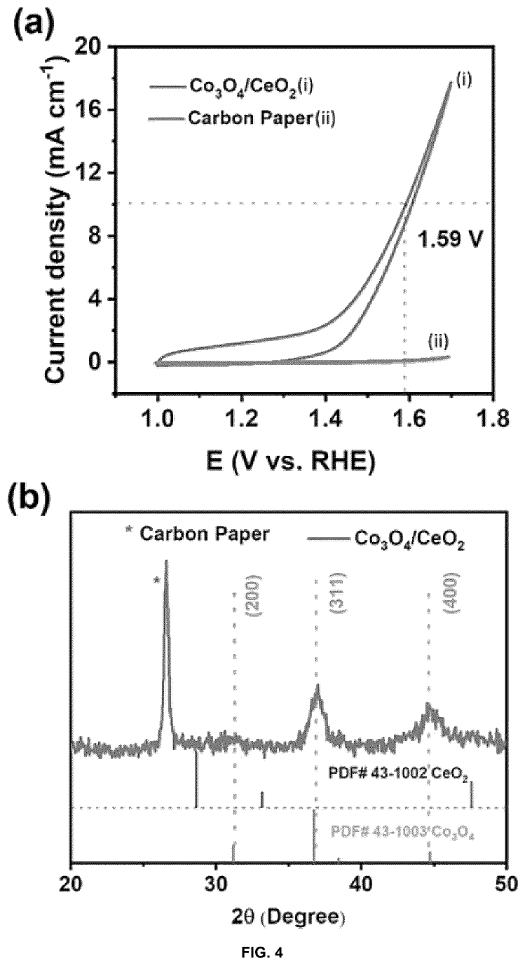

In order to accelerate the reaction rate, an electrode with acid OER catalyst (R. D. Ross et al., Nat. Commun. 2021, 3036) was used at the anodic side. The detailed characterization of the catalyst is shown in FIG. 4. The galvanostatic profile of the cell is shown in FIG. 3d—the cell can continuously decompose LCO at an average voltage plateau ˜1.8 V even at a current density as high as 50 mA cm⁻¹. Based on the theoretical capacity of LCO and the actual charge capacity, it was calculated that the Li⁺ and Co²⁺ leaching rate is about 98%. After the reaction, the remaining undissolved impurity (carbon black and polymer binder, et al.) can be easily removed from the tank.

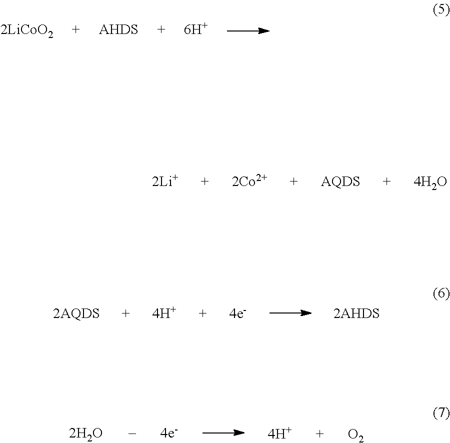

### Example 6. Selective Removal and Transfer of Lithium Ions

Although the protons in the cathode compartment will be supplemented from the opposite side, it can be seen from equation (5) that it is necessary to supplement 3 more protons to decompose 1 mol of LCO, so the concentration of protons in the solution decreases with the decomposition of LCO and the reaction will stop until the proton is consumed up. After the decomposition of LCO is finished, the dissolved LCO together with the electrolyte solution which contains Li⁺, Co²⁺, AQDS and supporting electrolyte, flows into an independent tank.

With LiOH addition to the mixed solution and when pH >10, Co²⁺ is precipitated and can be easily separated by centrifugation or filtration (equation (8)).

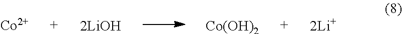

OCP test was carried out by following the protocol in Example 5.

### Results and Discussion

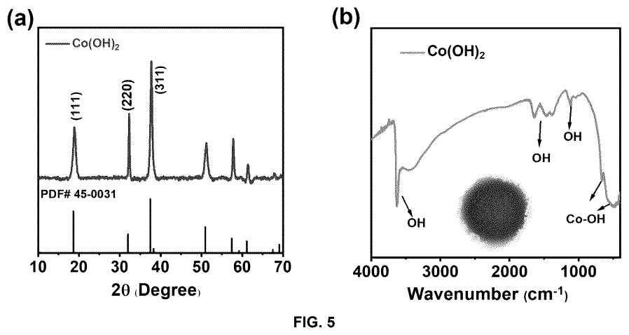

XRD measurement confirmed that the obtained solid is Co (OH)₂. A 98.5% recovery of cobalt and a high purity of 97.6% (as determined by ICP-OES measurement, FIG. 5) were achieved. Then, the filtered electrolyte solution containing AQDS and Li⁺ flows into the reductive lithium intercalation device.

To achieve the selective removal and transfer of lithium ions from AQDS-(NH₄)₂, an LIB cathode material is required as lithium insertion carriers, which needs to have a higher potential than AQDS-(NH₄)₂ such that the intercalation of lithium ions can be realized by reducing the electrode material by a redox mediator. Meanwhile, considering the limitation of the working voltage range in aqueous systems and since the process of releasing lithium ions from a solid material is an oxidation reaction, the solid material should have a moderate redox potential (<1 V) in neutral pH. We chose iron phosphate (LP) as the lithium ion intercalation carrier.

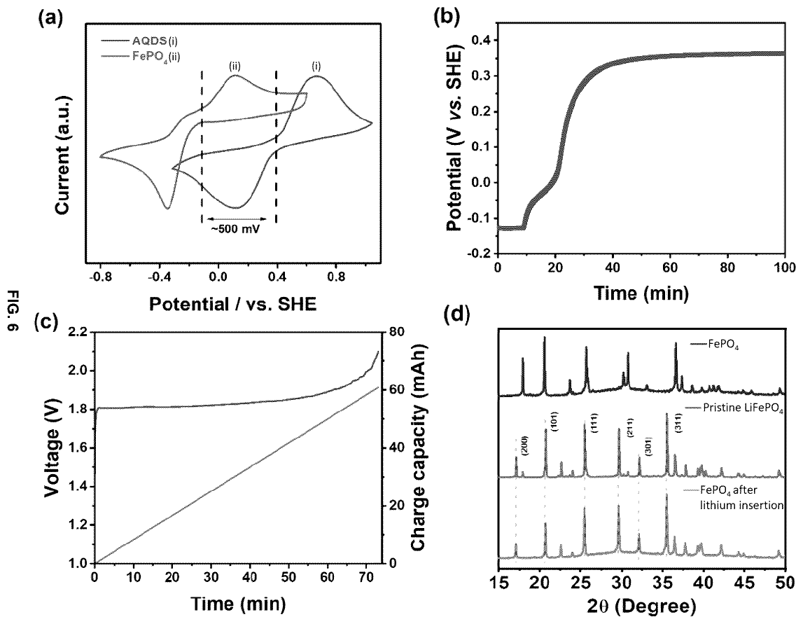

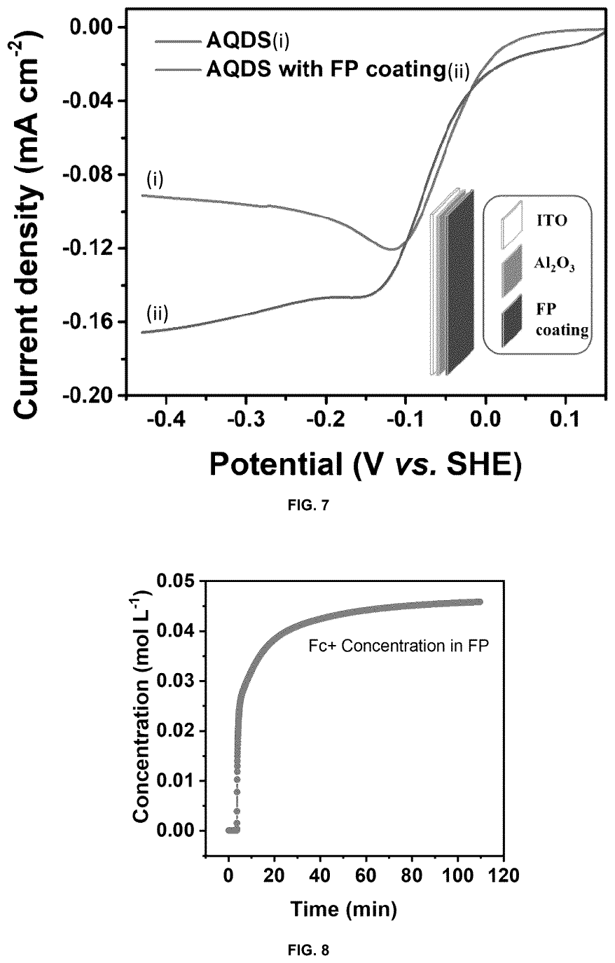

As shown in FIG. 6a, the potential of AQDS-(NH₄)₂ is −0.12 V (vs. SHE) in the 1 M lithium acetate solution and the potential difference between AQDS-(NH₄)₂ and FP is about 500 mV in the neutral solution, which provides a driving force to reduce FP by AQDS-(NH₄)₂. To verify the redox-targeting between FP and AQDS, at first, the double-layer experiment (as described in Example 5) was adopted to simulate the electrochemical and chemical process. The LSV results show that the reduction current intensity is significantly enhanced when there is FP coating on the Al₂O₃ layer (FIG. 7). Undoubtedly, the process of reductive lithium intercalation can be carried out smoothly.

To examine the reaction kinetics of the redox targeting between AQDS-(NH₄)₂ and FP, the OCP of 50 mM AHDS after adding 0.75 g of FP powder was monitored (FIGS. 6b and 8). The potential rose quickly from −0.12 V to 0.35 V in 35 min. In accordance with the OCP measurement, the LSV plot reveals no obvious oxidation current, suggesting that AHDS species have nearly depleted after the reaction.

### Example 7. Continuous Process of Electrochemical Reductive Lithium Intercalation

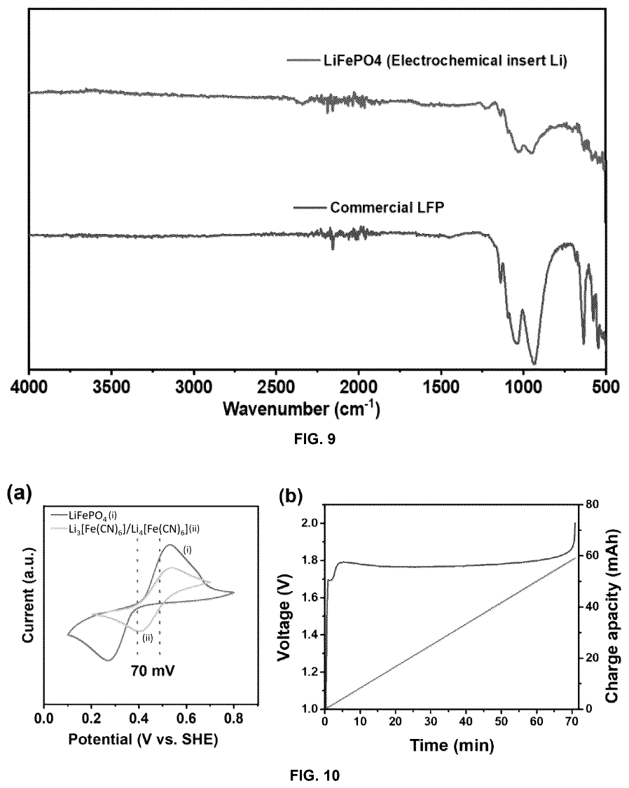

The same flow cell device as shown in FIG. 2a was used to investigate the continuous process of electrochemical reductive lithium intercalation. The electrolyte containing Li⁺ and AHDS flows to the cathode tank with pre-loaded FePO₄ (FP), in which the AHDS reduces FP while itself is oxidized to AQDS. The reduction of FP involves the insertion of Li⁺, forming LiFePO₄ (LFP, equation (9)). Then, the electrolyte solution containing AQDS is pumped back to the cathode compartment where it is reduced back to AHDS for the next cycle of reaction (equation (6)). On the anodic side, an OER reaction also occurs with the supply of water like in the first step (equation (7)), in which the generated protons are transported to the cathodic compartment through a cation-exchange membrane. The galvanostatic profile of the cell is shown in FIG. 6c. With Co₂O₃/Ce₃O₄ as the OER catalyst (R. D. Ross et al., Nat. Commun. 2021, 3036), all the electrolysis reactions proceed continuously with removal of Li⁺ from the first step of LCO decomposition and LiOH addition in the precipitation of Co²⁺ in the second step. Even when the current density was as high as 50 mA cm⁻², the voltage of the flow cell was 1.8 V. Since the above removal process of Co²⁺ introduce 2 times more amount of Li⁺, together with Li⁺ from LCO decomposition, theoretically, when these lithium ions in the solution are embedded into FP, the protons produced by the OER reaction simultaneously just supplement the extra protons consumed in the decomposition of LCO. Based on this point, the catholyte can just recover to the initial state before LCO decomposition and can be reused in the next round. By comparing the theoretical capacity of FP with the charging capacity during lithium intercalation, it was calculated that the lithium intercalation rate is as high as 99%. As the XRD pattern shows in FIG. 6d, all the indexed peaks of FePO₄ vanished but a new pattern consistent with that of LiFePO₄ appeared. The FT-IR spectrum (FIG. 9) further confirms that FePO₄ has been reduced by AQDS, accompanied by Li⁺ intercalation. These results clearly indicate that AQDS can effectively embed Li⁺ into FePO₄, thus realizing the fixation and transfer Li⁺ from the mixed solution.

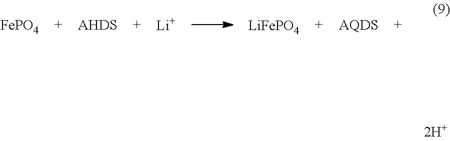

After the above three processes, lithium ions and cobalt ions were separated, but the lithium ions exist in the form of LFP which cannot be used freely. Combined with the previously reported method of electrochemical oxidation leaching from LFP (J. Yu et al., Energy Environ. Sci. 2019, 12, 2672-2677), high purity lithium hydroxide can be recovered.

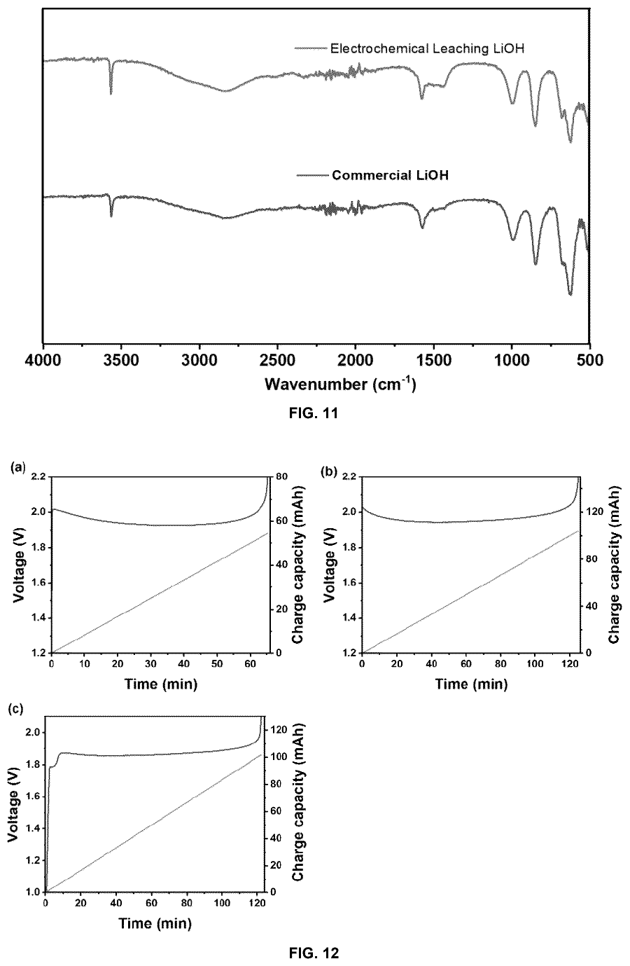

Here, based on redox targeting, similar tests were conducted with the above flow cell to extract lithium ions. In order to improve the reaction rate, HER was used instead of ORR, since the sluggish kinetics of ORR limits the current density to ˜10 mA cm⁻². The flow cell devices are similar to FIG. 1. Upon operation, the obtained LFP material from the third step was similarly loaded in the anodic reactor tank and broken down into FePO₄ and Li⁺ by the oxidation reaction with redox mediator [Fe(CN)₆]³⁻ dissolved in the anolyte (equation (10)). Along with Li⁺ in the electrolyte solution, the reduced redox mediator [Fe(CN)₆]⁴⁻ circulates to the anodic compartment, where it is regenerated back to [Fe(CN)₆]³⁻ for continuous reaction with LFP (equation (11)). At the same time, Li⁺ transports through the membrane to the cathodic compartment. Meanwhile, the HER reaction at the counter electrode not only similarly produces OH⁻ for the formation of LiOH, but it also produces high purity H₂ as a valuable by-product (equation (12)). When a carbon felt electrode with an OER catalyst is used as the cathode, the average voltage plateau was around 1.8 V at a high current density of 50 mA cm⁻² (FIG. 10). Based on the theoretical capacity of LFP and the actual value, it was calculated that the Li⁺ removal efficiency is >98% at ambient conditions with our high-throughput electrolytic flow cell. The purity of the obtained LiOH was as high as 99.9%, which means the obtained LiOH can be directly used for precipitating Co²⁺ or for other applications. Further, the FT-IR spectrum of LiOH is similar to that of commercial LiOH·H₂O (FIG. 11). More importantly, in this process, only water and electricity are consumed to obtain high-purity LiOH and FP which can be recycled.

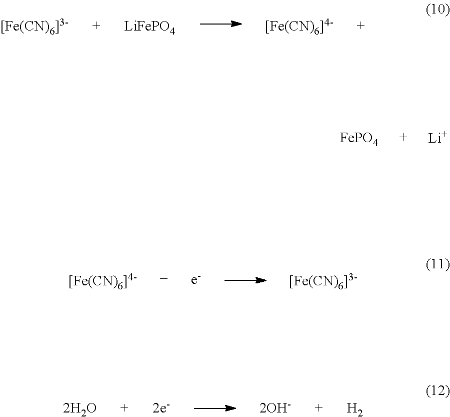

From the decomposition of LCO to the final separation and recovery of Li⁺ and Co²⁺, since FP can be recycled and reused, the obtained LiOH can also be directly used for the precipitation of Co²⁺. In this view, after combining the above 8 equations (equations (5)-(12)), it is easy to obtain equation (13). It can be clearly seen that with the above complementary and closed-loop reactions, the entire recycling process of LCO only requires the supply of water and electricity, and there is no need to add other chemical reagents to the system. In the end, the spent LCO is broken down into high-grade LiOH and Co(OH)₂. A continuous process shows 95% and 92.2% recovery rate of cobalt and lithium, respectively (FIG. 12).

A continuous process of recycling 0.2 g LCO in a 5 cm² electrolytic cell was conducted to demonstrate the whole leaching and recovery pathway. 30 mL of 50 mM AQDS in 3 M acetic acid was used as the starting electrolyte. After LCO leaching (FIG. 12a), cobalt was removed and precipitated as Co(OH)₂. 20 mL of the electrolyte was then used for lithium removal (FIG. 12b) by FePO₄, and the obtained LiFePO₄ was finally leached by 0.4 M Li₃Fe(CN)₆ to recover Li as LiOH.

All the above electrochemical process can be carried out smoothly at a current density of 50 mA cm⁻².

Taken together, at a current density of 50 mA cm⁻², the leaching rate of lithium cobalt oxide and the lithium insertion rate of FP were as high as 98% and 99%, respectively. When Li⁺ was leached from the obtained LFP under a high current density of 50 mA cm⁻², it can be separated in the form of LiOH with a high-purity and it can not only cover the precipitation consumption of Co²⁺, but it also can be used in other fields as high value-added chemicals. This cost-effective and environmentally-friendly method can be extended to other materials and promote the sustainability of LIB recycling technology. This fascinating closed-loop route provides new avenue for the green recycling of spent battery materials, and this is the first time the separation and recovery of metals in the form of high value-added chemicals from spent LCO batteries have been achieved through electrochemical and chemical methods.

### Example 8. NMC Electrode Materials

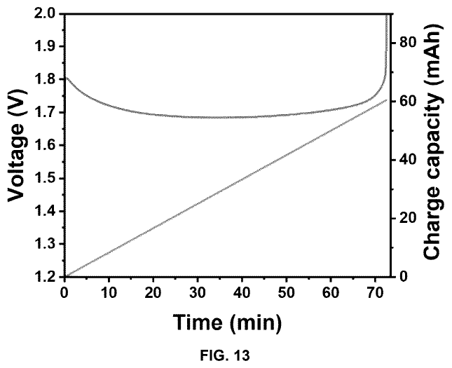

For NMC electrode materials, the method of reductive decomposition was also used. As shown in FIG. 10, 50 mM AQDS was used as the mediator molecule to test the battery under 0.5 M sulfuric acid. The counter electrode (anode) is the OER reaction, and the whole reaction was at a current density of 10 mA cm⁻², and the battery voltage was 1.7 V (FIG. 13).

Therefore, we have developed a high-throughput electrolytic flow cell system based on redox targeting, which not only realizes the continuous decomposition of spent LIBs materials, but also achieve the separation and recovery of metal ions in electrode materials, and at the same time, obtains high value-added with high purity chemical product. As a suitable redox medium, AQDS-(NH₄)₂ can efficiently and continuously decompose LCO. The leaching rate of Li⁺ and Co²⁺ is as high as 98% in acetic acid. At the same time, AQDS-(NH₄)₂ can also be used as an ideal redox mediator for reducing FP for lithium insertion, realizing the continuity of the two processes of decomposing LCO and separating metal Li⁺. The fast reaction kinetics also ensures that each step of the reaction proceed smoothly at a current density of up to 50 mA cm⁻². The high current density provides the possibility for practical industrial applications. In addition, the complete closed-loop route does not require the addition of additional chemicals and will not cause secondary pollution, which truly realizes the green chemical process. This unique design strategy can be easily applied to other spent battery materials, such as NMC materials. These green, closed-loop technologies based on redox targeting provide the possibility for a wide range of applications in sustainable recycling of waste batteries.

### Example 9. Reductive Leaching of LCO and Selective Removal of Co²⁺ and Li⁺ Setup (Path 2)

FIG. 14 illustrates a different pathway (Path 2) for the reductive leaching of LCO and selective removal of Co²⁺ and Li⁺. As depicted in FIG. 14, the device includes includes tank I 101, tank II 103, tank III 102, tanks IV 104, pumps 107, anion exchange membranes 201, and power supply 109.

With a two-electrolyzer configuration shown in FIG. 14, the reductive leaching of LCO and removal of Co²⁺ and Li⁺ can proceed simultaneously. The detailed operations are described below.

Step 1: Reductive leaching of LCO with electrolyzer A. The procedure is the same as Step 1 in Path 1 (see Example 4).

Step 2: The leached electrolyte solution containing Li⁺, Co²⁺, RM₁ and supporting electrolyte flows into tank III, in which Co²⁺ is removed by adding LiOH. The formed Co(OH)₂ precipitate is separated from the electrolyte solution.

Step 3: The remaining electrolyte solution containing Li⁺ and RM₁ continues to flow into tank II. With the help of electrolyzer A′, Li⁺ is removed by FP in tank II, as those stated in Step 3 in Path 1 (see Example 4). During this process, protons are accumulated in the electrolyte solution.

Step 4: As the pH of electrolyte solution in tank II becomes <3, the electrolyte solution in tank II containing protons and RM₁ is then returned to tank I. Those in tank I proceed again from Step 1, starting a second round of reactions.

Step 5: As FP in tank Il is fully converted into LFP, it is transferred to electrolyzer B as those stated in Path 1, Step 4 (see FIG. 1 and Example 4) for oxidative leaching of LFP and separation of Li⁺.

### Example 10. Reductive Leaching of LCO and Selective Removal of Co²⁺ and Li⁺ (Path 2)

LCO was used as an example to demonstrate the individual steps of Path 2 (as described in Example 9). Robust redox mediators (RMs) with potential lower than those of LCO and LFP could be used for reductive leaching. Here, two RMs were used as examples. The redox potentials of Fc-SO₃Li and AQDS-2NH₄ were measured in 50 mM H₂SO₄ by CV method as described in Example 5.

### Results and Discussion

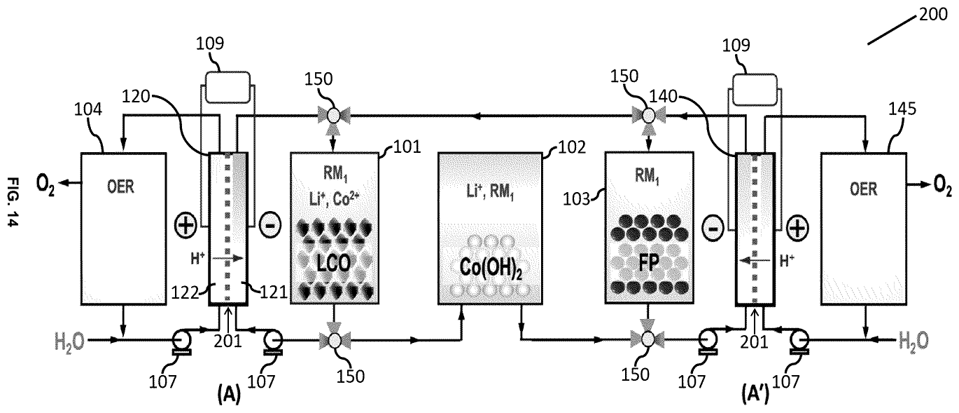

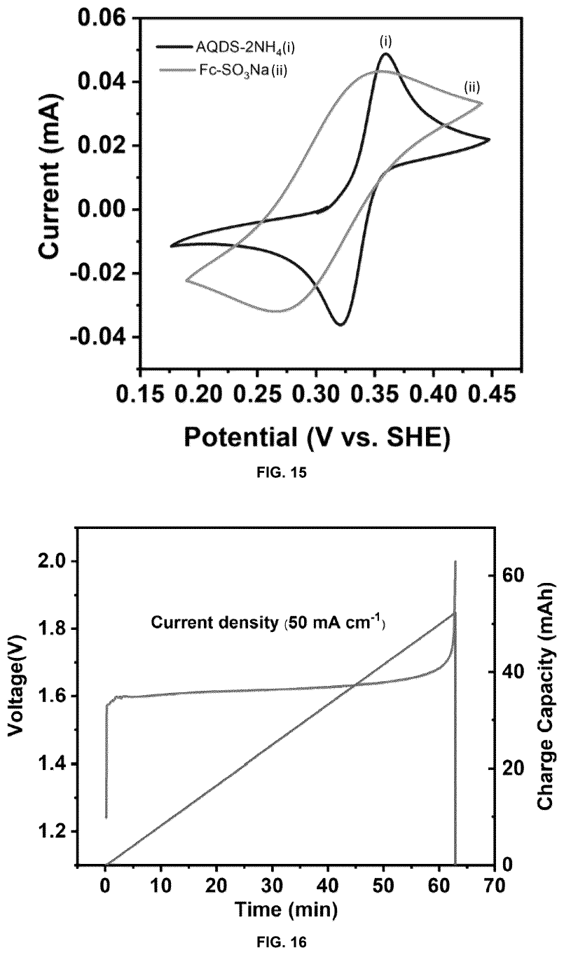

As shown in FIG. 15, the redox potentials of Fc-SO₃Li and AQDS-2NH₄ were 0.31 V and 0.23 V (vs. SHE), respectively, which are lower than that of LCO (˜1 V vs. SHE). This makes them suitable to be used as RM₁ for the reductive leaching of LCO.

The reductive leaching of LCO was carried out in an electrolytic flow cell which used 40 mM Fc-SO₃Li as the mediator in the 0.5 M H₂SO₄ solution in the cathodic compartment loaded with waste LCO. For the counter electrode (anode), 0.5 M H₂SO₄ was used as the supporting electrolyte, and carbon material with OER catalyst was used as the electrode for OER reaction. As shown in FIG. 16, the average voltage plateau was around 1.60 V at a constant current density of 50 mA/cm². Calculation based on the theoretical capacity and the actual capacity of LCO indicates that the leaching rate of the material was 98%.

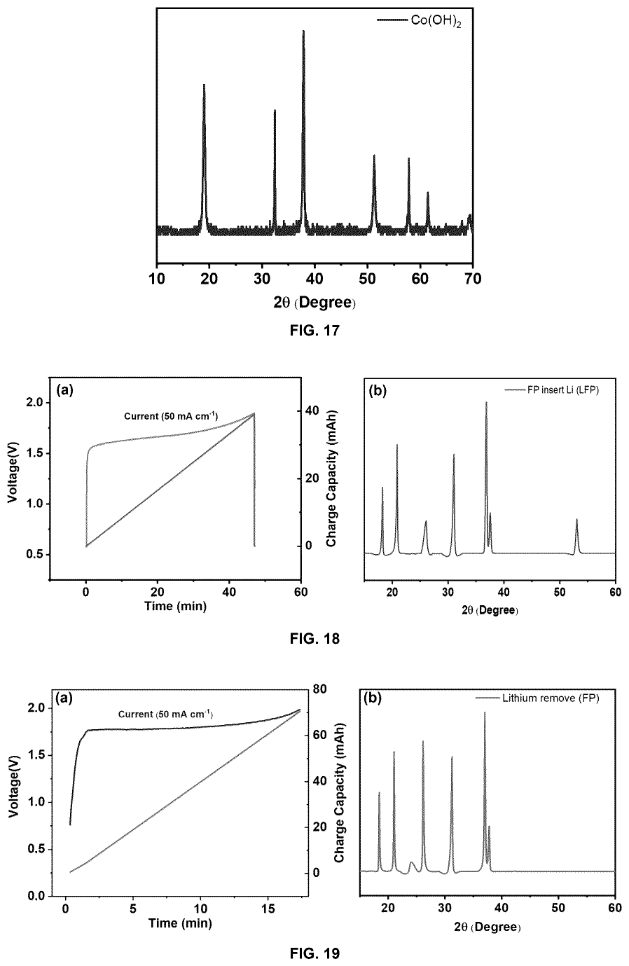

LiOH was added to the leached electrolyte solution, stirred and filtered. Co²⁺ was nearly completely separated from the solution, in the form of Co(OH)₂ precipitates. The XRD of Co(OH)₂ is shown in FIG. 17 and the recovery rate of cobalt reached 95% at pH=10.

The filtrate solution containing Li⁺ and Fc-SO₃⁻ was directly used as the catholyte of the same electrolytic flow cell while with FP loaded in the tank for Li⁺ removal. The average voltage plateau was around 1.7˜1.9 V at a constant current density of 50 mA/cm². Calculation based on the theoretical capacity and the actual capacity of FP concludes that the Li⁺ insertion rate was 97%, as shown in FIG. 18a. The XRD pattern of the obtained LFP after lithium insertion is shown in FIG. 18b.

The obtained LFP was transferred into the anodic reservoir of a second electrolytic flow cell, which contains Li₃[Fe(CN)₆] as the redox mediator (RM₂). LFP was continuously oxidized by [Fe(CN)₆]³⁻ and broken down into FP and Li⁺. HER reaction occurs at the counter electrode and produces OH⁻ with the supply of water. During this process, Li⁺ ions pass through the membrane to the cathode, and forms LiOH solution in the cathodic tank, achieving the recovery of lithium. As shown in FIG. 19a, the voltage of the cell was around 1.8˜1.9 V at a constant current density of 50 mA/cm². The XRD pattern shows that the original LFP solid turned into FP after lithium leaching. (FIG. 19b).

1. A method of recycling a spent battery material, the method comprising the steps of:
(a) providing a first reaction compartment fluidly connected to a cathode side of an electrolyser that comprises a cathode compartment comprising a cathode, an anode compartment comprising an anode, and a cation exchange membrane separating the cathode and the anode compartments from one another, where an anode side of the electrolyser is set up to generate protons via an oxygen evolution reaction or a hydrogen oxidation reaction, where in an initial state the first reaction compartment comprises:
a solid spent battery material comprising LiCoO₂ and/or LiNiₓMn_{y}Co_{z}O₂; and
an acidic electrolyte comprising a first redox mediator capable of being reduced on the cathode, and
during a first reductive loop, the acidic electrolyte from the first reaction compartment is provided to the first cathode compartment to provide a reduced first redox mediator and the acidic electrolyte is returned to the first reaction compartment where the reduced redox mediator reacts with the solid spent battery material producing soluble Li⁺, Co²⁺ and, when present, Ni²⁺ and Mn²⁺ ions, while the reduced first redox mediator is oxidised back to its original form and protons are supplied from the anode compartment via the cation exchange membrane,
during subsequent reductive loops, the acidic electrolyte from the first reaction compartment comprises the first redox mediator, and Li⁺, Co²⁺ and, when present, Ni²⁺ and Mn²⁺ ions,
the subsequent reaction loops are continued until the Li, Co and, when present, Ni and Mn have been dissolved from the solid spent battery material, whereupon the acidic electrolyte comprising the first redox mediator, and Li⁺, Co²⁺ and, when present, Ni²⁺ and Mn²⁺ ions is supplied to a second reaction compartment;
(b) in the second reaction compartment, the acidic electrolyte comprising the first redox mediator, and Li⁺, Co²⁺ and, when present, Ni²⁺ and Mn²⁺ ions, LiOH is added to precipitate the Co²⁺ and, when present, Ni²⁺ and Mn²⁺ ions to provide a filtered alkaline electrolyte solution comprising the first redox mediator, and Li⁺, which is supplied to a third reaction compartment when the Co²⁺ and, when present, Ni²⁺ and Mn²⁺ ions are substantially or are entirely removed from the filtered alkaline electrolyte solution by precipitation;
(c) in an initial state, the reaction compartment houses FePO₄ and accepts the filtered alkaline electrolyte solution from the second reaction compartment,
during a first reaction loop, the filtered alkaline electrolyte is supplied from the third reaction compartment to the cathode compartment to provide an electrolyte comprising a reduced first redox mediator and Li⁺ ions and the electrolyte is returned to the third reaction compartment where the reduced redox mediator reacts with the FePO₄ producing LiFePO₄ and the reduced first redox mediator is oxidised back to its original form and protons are supplied from the anode compartment via the cation exchange membrane,
during subsequent reaction loops, the electrolyte from the third reaction compartment comprises the first redox mediator, and a reduced concentration of Li⁺ ions,
the subsequent reaction loops are continued until the Li⁺ ions are substantially or are entirely removed from the electrolyte, such that the electrolyte matches, or substantially matches, the acidic electrolyte of step (b), at which point the LiFePO₄ and any remaining FePO₄ are harvested.

2. The method according to claim 1, further comprising the steps of:
(i) providing a fourth reaction compartment fluidly connected to an anode side of an electrolyser that comprises an anode compartment comprising an anode, a cathode compartment comprising cathode, and a cation exchange membrane separating the cathode and the anode compartments from one another, where the cathode side of the electrolyser is set up to generate hydrogen gas and hydroxide ions via a hydrogen evolution reaction, the cathode compartment being fluidly connected to a storage tank, where in an initial state the fourth reaction compartment comprises:
the fourth reaction compartment the LiFePO₄ and any remaining FePO₄ harvested from step (d) of claim 1 and an electrolyte comprising a second redox mediator capable of being oxidised on the anode; and
the storage tank comprises water,
during a first reaction loop, the electrolyte from the fourth reaction compartment is provided to the anode compartment to provide an oxidised second redox mediator and the electrolyte is returned to the fourth reaction compartment where the oxidised redox mediator reacts with the LiFePO₄ to provide FePO₄ and Li⁺ ions,
during subsequent reaction loops the electrolyte comprising the redox mediator and Li⁺ ions is supplied to the anode compartment, where:
the redox mediator is converted into an oxidised redox mediator; and
at least some of the Li⁺ ions are transported through the cation exchange membrane into the cathode compartment and hence to the storage tank,
the subsequent reaction loops are continued until the LiFePO₄ is substantially or entirely consumed and the storage tank comprises aqueous lithium hydroxide solution.

3. The method according to claim 1, wherein the first redox mediator has a redox potential lower than LiCoO₂ and/or LiNiₓMn_{y}CO_{z}O₂, optionally wherein the first redox mediator has a redox potential of less than 0.4 V vs standard hydrogen electrode (SHE), such as from 0.05 to 0.39 V vs SHE, such as about 0.23 V vs SHE or about 0.31 V vs SHE.

4. The method according to claim 3, wherein the first redox mediator is one or both of Fe—SO₃Li and AQDS-2NH₄.

5. The method according to claim 1, wherein the first redox mediator has a concentration of from 1 to 100 mM in the acidic electrolyte, such as from 2 to 50 mM, such as about 40 mM or about 5 mM.

6. The method according to claim 1, wherein the acidic electrolyte is formed from water and an acidic compound, optionally wherein the acidic compound has a concentration of from 0.2 M to 5 M, such as from about 0.4 M to 3 M, further optionally wherein the acidic compound is sulphuric acid or acetic acid.

7. The method according to claim 2, wherein the second redox mediator is Li₃[Fe(CN₆)].

8. The method according to claim 1, wherein the method is operated as a closed loop.

9. An electrolytic device comprising:
an electrolyser, which comprises a first cathode compartment comprising a cathode, a first anode compartment comprising an anode and a cation exchange membrane separating the first cathode and the first anode compartments from one another;
a first to third cathode tank, where:
the first cathode tank is fluidly connected to at least the cathode compartment and to the second cathode tank;
the second cathode tank is fluidly connected to at least the first cathode tank and to the third cathode tank and can accept LiOH;
the third cathode tank is fluidly connected to at least the first cathode tank, the second cathode tank and the first cathode compartment; and
an anode tank fluidly connected to the first anode compartment, wherein:
each of the first and third cathode tanks can be independently selected to be fluidly connected to the cathode compartment at any given time;
the first cathode tank is configured to accept a spent battery material and an electrolyte and supply a liquid to the second cathode tank;
the second cathode tank is configured to accept a liquid from the first cathode tank and to accept LiOH in solid and/or liquid form, and supply a liquid the third cathode tank; and
the third cathode tank is configured to accept a liquid from the second cathode tank.

10. An electrolytic device comprising:
a first electrolyser, which comprises a first cathode compartment comprising a cathode, a first anode compartment comprising an anode and a cation exchange membrane separating the first cathode and the first anode compartments from one another;
a second electrolyser, which comprises a second cathode compartment comprising a cathode, a second anode compartment comprising an anode and a cation exchange membrane separating the first cathode and the first anode compartments from one another;
a first anode tank fluidly connected to the first anode compartment;
a second anode tank fluidly connected to the second anode compartment;
a first cathode tank fluidly connected to the first cathode compartment;
a second cathode tank fluidly connected to the second cathode compartment;
a third cathode tank fluidly connected to the first cathode tank and the second cathode tank.

11. The method according to claim 2, wherein the first redox mediator has a redox potential lower than LiCoO₂ and/or LiNiₓMn_{y}Co_{z}O₂, optionally wherein the first redox mediator has a redox potential of less than 0.4 V vs standard hydrogen electrode (SHE), such as from 0.05 to 0.39 V vs SHE, such as about 0.23 V vs SHE or about 0.31 V vs SHE.

12. The method according to claim 11, wherein the first redox mediator is one or both of Fe-SO₃Li and AQDS-2NH₄.
